(19) United States
(12) Patent Application Publication
(10) Pub. No.: US 2025/0199426 A1
(43) Pub. Date: Jun. 19, 2025

(54) TONER

(71) Applicant: CANON KABUSHIKI KAISHA, Tokyo (JP)

(72) Inventors: JUNICHI TAMURA, Ibaraki (JP); TAKESHI HASHIMOTO, Ibaraki (JP); GAKU SATO, Chiba (JP); HAYATO IDA, Ibaraki (JP)

(21) Appl. No.: 18/971,807

(22) Filed: Dec. 6, 2024

(30) Foreign Application Priority Data
Dec. 13, 2023 (JP) 2023-210561

(51) Int. Cl. G03G 9/087; C08F 220/46

(52) U.S. Cl. CPC G03G 9/08731; C08F 220/46; G03G 9/08711

(57) ABSTRACT

A toner having a toner particle including a binder resin, wherein the binder resin includes a crystalline vinyl resin having a specific monomer unit having at least two long-chain alkyl groups, the crystalline vinyl resin contains at least 5.0% by mass of the specific monomer unit having at least two long-chain alkyl groups, based on the mass of the crystalline vinyl resin, the toner particle contains at least one polyvalent metal selected from the group consisting of Mg, Ca, Al, and Zn, and a content ratio of the polyvalent metal in the toner particle is 25 ppm by mass to 500 ppm by mass.

### BACKGROUND OF THE INVENTION

### Field of the Invention

The present disclosure relates to a toner used for an electrophotographic method, an electrostatic recording method, an electrostatic printing method, and a toner jet method.

### Description of the Related Art

The demand for delivering higher printing speeds and greater energy savings has become more exacting in recent years, accompanying the growing use of electrophotographic full-color copiers. In the framework of the Sustainable Development Goals (SDGs) adopted by the United Nations, in particular, efforts are being made worldwide that are aimed at curbing greenhouse gases such as CO2, while energy conservation demands are likewise becoming stronger. Energy-saving approaches being addressed include techniques for fixing toner at a lower temperature, for the purpose of reducing power consumption in a fixing process.

It is known that a toner including, as a main component, a crystalline resin, which has a sharp melt property has low-temperature fixability superior to that of a toner including, as a main component, an amorphous resin.

For example, Japanese Patent Application Publication No. 2014-066994 proposes a toner that achieves both excellent low-temperature fixability and heat-resistant storage stability by having a crystalline resin as a matrix and an amorphous resin as domains. In addition, Japanese Patent Application Publication No. 2019-215527 proposes a toner using a crystalline vinyl resin.

### SUMMARY OF THE INVENTION

However, where the main component of the binder resin of the toner is a crystalline resin having a sharp melt property, the image after fixing may become brittle and may have a reduced abrasion resistance thus, where the printed matter is rubbed under a load created by the printed matter being stacked on top of each other, the image may peel off and be transferred to the back surface of the upper sheet. Japanese Patent Application Publication No. 2019-219640 discloses including a polyvalent metal in a toner and forming pseudo-crosslinking of a polar group of a crystalline resin and the polyvalent metal. According to the study by the present inventors, such pseudo-crosslinking can improve abrasion resistance.

As described above, toners containing crystalline vinyl resins such as behenyl acrylate, as the main component of the binder resin, can be fixed at a lower fixing temperature than before. Furthermore, when the toner contains a polyvalent metal, the polyvalent metal can be pseudo-crosslinked with the polar group of the resin, thereby improving the abrasion resistance. However, the inventors recognized that, compared to the conventional toners, such pseudo-crosslinked toners are more susceptible to image sticking, in which the sheets of paper stuck together due to static electricity when the sheets of paper output from a copier are stacked, causing transport problems when the sheets are transported to the subsequent process.

The present disclosure provides a toner that has excellent low-temperature fixability, and that has excellent charge retention property and storage stability while achieving both abrasion resistance and image sticking resistance.

The present disclosure relates to a toner comprising a toner particle comprising a binder resin, wherein
the binder resin comprises a crystalline vinyl resin having a monomer unit represented by a following formula (1),
the crystalline vinyl resin comprises at least 5.0% by mass of the monomer unit represented by the following formula (1), based on a mass of the crystalline vinyl resin,
the toner particle comprises at least one polyvalent metal selected from the group consisting of Mg, Ca, Al, and Zn, and
a content ratio of the polyvalent metal in the toner particle is 25 to 500 ppm by mass:

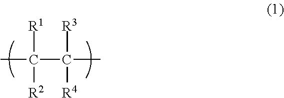

in the formula (1), at least two of R¹ to R⁴ are each independently —X—COOR⁵, and the remaining are each independently a hydrogen atom or an alkyl group having 1 to 4 carbon atoms, X is a single bond or an alkylene group having 1 or 2 carbon atoms, and R⁵ is an alkyl group having 16 to 30 carbon atoms.

The present disclosure can provide a toner that has excellent low-temperature fixability, and that has excellent charge retention property and storage stability while achieving both abrasion resistance and image sticking resistance.

Further features of the present invention will become apparent from the following description of exemplary embodiments.

### DESCRIPTION OF THE EMBODIMENTS

In the present disclosure, the descriptions “from XX to YY” and “XX to YY” that represent numerical ranges mean numerical ranges including the lower and upper limits that are the endpoints, unless otherwise specified. When numerical ranges are described in stages, the upper and lower limits of the numerical ranges can be combined in a freely selected manner.

In addition, in the present disclosure, for example, a description such as “at least one selected from the group consisting of XX, YY, and ZZ” means any of XX, YY, ZZ, a combination of XX and YY, a combination of XX and ZZ, a combination of YY and ZZ, or a combination of XX, YY, and ZZ.

“Monomer unit” refers to the reacted form of a monomer substance in a polymer. For example, one section of carbon-carbon bonds in the main chain of a polymer in which vinyl monomers are polymerized is considered to be one unit. A vinyl monomer can be expressed by a following formula (3).

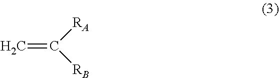

In formula (3), RA represents a hydrogen atom or an alkyl group (preferably an alkyl group having 1 to 3 carbon atoms, more preferably a methyl group), and RB represents any substituent.

Crystalline vinyl resin refers to a resin that shows a clear endothermic peak in differential scanning calorimetry (DSC) measurement and is synthesized from a freely selected vinyl monomer.

The present inventors consider that the toner according to the present disclosure can achieve both abrasion resistance and image sticking resistance according to the following mechanism.

Conventionally, crystalline vinyl resins used in toners, such as behenyl acrylate, have low abrasion resistance because the crystal domains are small and brittle. Therefore, by providing a polar group to the crystalline vinyl resin and incorporating a polyvalent metal in the toner to pseudo-crosslink the polar group and the polyvalent metal, the toner becomes hard and the abrasion resistance is improved. However, there is room for improvement because due to the formation of a pseudo-crosslink of the polar group with the polyvalent metal, charges are unlikely to diffuse, and when an image is output, the papers stick to each other due to static electricity, making it impossible to immediately transport the paper thereafter.

As a result of intensive research, the inventors have found that the above problems can be solved by using a monomer unit represented by formula (1) in the crystalline vinyl resin and further incorporating a polyvalent metal in a toner particle. When the monomer unit represented by formula (1) is used, a plurality of long-chain alkyls in the monomer unit extend in different directions and crystallize, resulting in larger and harder crystalline domains.

Where the crystalline domains become larger, the charge travel distance becomes longer and the distance between the crystalline domains also increases, resulting in a longer charge leak path and making it difficult for the charge to diffuse. However, the presence of a polyvalent metal therein can improve charge diffusion, which is thought to be capable of suppressing image sticking.

The crystalline vinyl resin preferably has a polar group such as —C═N, —COOH, or —OH. The polar group contained in the crystalline vinyl resin allows the polyvalent metal to bond to the crystalline domain, further improving charge diffusion. Furthermore, since the crystal domains are large, the polar groups on the surface are suppressed and the distance between the crystal domains is long, making it difficult for pseudo-crosslinking to occur, and the polyvalent metal is not completely restrained. It is presumed that this can improve, even further, charge diffusion and further suppress image sticking.

The present disclosure relates to a toner comprising a toner particle comprising a binder resin, wherein
the binder resin comprises a crystalline vinyl resin having a monomer unit represented by a following formula (1),
the crystalline vinyl resin comprises at least 5.0% by mass of the monomer unit represented by the following formula (1), based on a mass of the crystalline vinyl resin,
the toner particle comprises at least one polyvalent metal selected from the group consisting of Mg, Ca, Al, and Zn, and
a content ratio of the polyvalent metal in the toner particle is 25 to 500 ppm by mass:

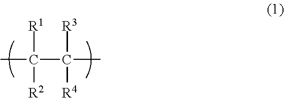

in the formula (1), at least two of R¹ to R⁴ are each independently —X—COOR⁵, and the remaining are each independently a hydrogen atom or an alkyl group having 1 to 4 carbon atoms, X is a single bond or an alkylene group having 1 or 2 carbon atoms, and R⁵ is an alkyl group having 16 to 30 carbon atoms.

In the toner of the present disclosure, the binder resin includes a crystalline vinyl resin having a monomer unit represented by formula (1), and the content of the monomer unit represented by formula (1) is 5.0% by mass or more based on the mass of the crystalline vinyl resin. At least two of R¹ to R⁴ in formula (1) are each independently —X—COOR⁵, and the remaining are each independently a hydrogen atom or an alkyl group having 1 to 4 carbon atoms. X is a single bond or an alkylene group having 1 or 2 carbon atoms, and R⁵ is an alkyl group having 16 to 30 carbon atoms.

With the monomer unit represented by formula (1), the distance between the alkyl group side chains of the crystalline vinyl resin is shortened, making it easier for the crystalline domains in the toner to grow, improving the sharp melt property and resulting in good low-temperature fixability. Where R⁵ exceeds 30, low-temperature fixability is likely to decrease. Also, where R⁵ is less than 16, storage stability is likely to decrease. Also, where only one of R¹ to R⁴ is —X—COOR⁵, the crystal domains are unlikely to grow large, making it difficult to obtain the effect of suppressing image sticking described above.

To obtain more grown crystal domains, it is preferable that at least two of R¹ to R⁴ in formula (1) be —COOR⁵ (R⁵ is an alkyl group having 16 to 30 carbon atoms). In addition, in formula (1), it is more preferable that either R¹ or R² and either R³ or R⁴ are each independently —COOR⁵ (R⁵ is an alkyl group having 16 to 30 carbon atoms). R⁵ is preferably an alkyl group having 18 to 28 carbon atoms, and more preferably an alkyl group having 18 to 24 carbon atoms. It is preferable that the alkyl group of R⁵ be linear. It is even more preferable that R⁵ be a linear alkyl group having 18 carbon atoms or a linear alkyl group having 22 carbon atoms.

The crystalline vinyl resin contains 5.0% by mass or more of the monomer unit represented by formula (1) based on the mass of the crystalline vinyl resin. Where the content of the monomer unit represented by formula (1) is 5.0% by mass or more, the low-temperature fixability is improved. In addition, the abrasion resistance and charge retention property are also improved. Since the low-temperature fixability is improved as the content of the unit of formula (1) is increased, it is preferable that the crystalline vinyl resin contain the monomer unit represented by formula (1) in an amount of 30.0% by mass or more. The content of the monomer unit represented by formula (1) is preferably 5.0% by mass to 85.0% by mass, more preferably 30.0% by mass to 80.0% by mass, and even more preferably 45.0% by mass to 75.0% by mass based on the mass of the crystalline vinyl resin.

Similarly, from the viewpoint of low-temperature fixability, the content ratio of the crystalline vinyl resin is preferably 30% or more, and more preferably 50% or more based on the mass of the binder resin. Meanwhile, from the viewpoint of storage stability, it is preferable that the content ratio of the crystalline vinyl resin be 80% or less based on the mass of the binder resin. The content ratio of the crystalline vinyl resin based on the weight of the binder resin is preferably 30% by mass to 80% by mass, more preferably 50% by mass to 80% by mass, and even more preferably 50% by mass to 70% by mass.

In the toner, the toner particle contains a binder resin and at least one polyvalent metal selected from the group consisting of Mg, Ca, Al, and Zn. The content ratio of the polyvalent metal needs to be 25 ppm to 500 ppm based on the weight of the toner particle.

Where the amount of the polyvalent metal is within the above range, charge diffusion becomes appropriate and image sticking is suppressed. Where the amount of the polyvalent metal is less than 25 ppm, charge diffusion becomes insufficient and image sticking is likely to occur. Furthermore, where the amount of the polyvalent metal is more than 500 ppm, charge diffusion becomes excessive, the charge retention property of the toner under high temperature and high humidity conditions decreases, and when printing again after a long print interval, a recovery operation is required until the charge quantity of the toner increases.

The content ratio of the polyvalent metal in the toner particle is preferably 100 ppm to 400 ppm by mass, and more preferably 150 ppm to 350 ppm. When the toner particles are manufactured by the emulsion aggregation method, the content ratio of the polyvalent metal in the toner particle can be controlled by using a flocculant containing the polyvalent metal and changing the amount of the flocculant added in the aggregation step. Where other methods for manufacturing toner particles are used, the polyvalent metal can be included in the above range by a freely selected method.

It is preferable that the content ratio (ppm by mass) of the polyvalent metal based on the mass of the toner particle, and the content ratio of the monomer unit represented by formula (1) and based on the mass of the toner particles (% by mass) satisfy the following formula (2).

$$( Content ratio of polyvalent metal ) / ( Content ratio of monomer unit represented by formula ( 1 ) ) \geq 1. ( ppm / \% by mass ) \qquad ( 2 )$$

Where the above ratio is within the range represented by formula (2), sufficient amount of polyvalent metal is present in the crystal domains, charge diffusion is good, and image sticking can be further suppressed. (Content ratio of polyvalent metal)/(Content ratio of monomer unit represented by formula (1)) is preferably 1.0 (ppm/% by mass) to 25.0 (ppm/% by mass), and more preferably 4.0 (ppm/% by mass) to 12.0 (ppm/% by mass).

In the crystalline vinyl resin, the polymerizable monomers capable of forming the monomer unit represented by formula (1) may be used alone or in combination of two or more kinds.

The crystalline vinyl resin may contain monomer units other than the monomer unit represented by formula (1) as necessary to the extent that the effect of the present disclosure is not impaired.

Examples of polymerizable monomers that form other monomer units include monomers having a nitrile group, such as acrylonitrile, methacrylonitrile, and 2-hydroxyethyl (meth)acrylate, 2-hydroxypropyl (meth)acrylate, 2-hydroxyethyl (meth)acrylate amide, and 2-hydroxypropyl (meth)acrylate amide.

Among these, it is preferable to use at least one polymerizable monomer selected from the group consisting of acrylonitrile, methacrylonitrile, acrylic acid, and methacrylic acid. These polymerizable monomers can impart high polarity to the crystalline vinyl resin. The polarity of the crystalline vinyl resin not only improves adhesion to paper and further improves fixing performance, but also contributes to charge diffusion as described above, making it easier to suppress image sticking. Furthermore, since the polar group also interacts with the polyvalent metal, the polyvalent metal in the toner particles is uniformly dispersed, making it easier to suppress image sticking. It is more preferable to use at least one polymerizable monomer selected from the group consisting of acrylonitrile and methacrylonitrile, and at least one polymerizable monomer selected from the group consisting of 2-hydroxyethyl (meth)acrylate and 2-hydroxypropyl (meth)acrylate.

The crystalline vinyl resin preferably contains a monomer unit represented by the following formula (N). The monomer unit represented by the following formula (N) corresponds to acrylonitrile and methacrylonitrile. The crystalline vinyl resin may also contain a monomer unit represented by the following formula (H). The monomer unit represented by formula (H) corresponds to 2-hydroxyethyl (meth)acrylate, 2-hydroxypropyl (meth)acrylate, and the like. In other words, the crystalline vinyl resin preferably contains at least one monomer unit selected from the group consisting of a monomer unit represented by the following formula (N) and a monomer unit represented by the following formula (H).

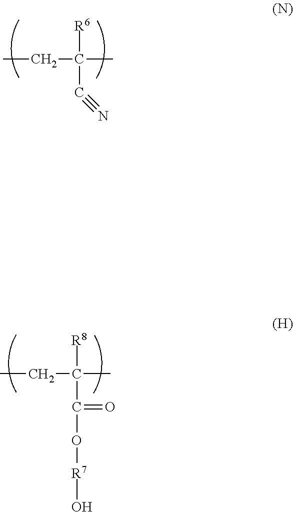

In formula (N), R⁶ is a hydrogen atom or a methyl group. In formula (H), R⁷ is an alkylene group having 1 to 4 (preferably 2 or 3) carbon atoms, and R⁸ is a hydrogen atom or a methyl group.

The content of the monomer unit represented by formula (N) in the crystalline vinyl resin is preferably4.0% by mass to 45.0% by mass, and more preferably 5.5% by mass to 35.0% by mass. The crystalline vinyl resin contains preferably 10.0% by mass to 35.0% by mass, and more preferably 15.0% by mass to 35.0% by mass of the monomer unit represented by formula (H). The total content of the monomer unit represented by formula (N) and the monomer unit represented by formula (H) in the crystalline vinyl resin is preferably 4.0% by mass to 45.0% by mass, and more preferably 5.5% by mass to 35.0% by mass.

Other examples of polymerizable monomers that form monomer units other than the monomer unit represented by formula (1) include the following polymerizable monomers.

Monomers having an amide group: for example, acrylamides and monomers obtained by reacting an amine having 1 to 30 carbon atoms with a carboxylic acid having 2 to 30 carbon atoms and an ethylenically unsaturated bond (acrylic acid, methacrylic acid, and the like) by a known method.

Monomers having a urea group: for example, monomers obtained by reacting an amine having 3 to 22 carbon atoms [primary amines (normal butylamine, t-butylamine, propylamine, isopropylamine, and the like), secondary amines (di-normal ethylamine, di-normal propylamine, di-normal butylamine, and the like), aniline, cycloxylamine, and the like] with an isocyanate having 2 to 30 carbon atoms and an ethylenically unsaturated bond by a known method.

Monomers having a carboxy group: for example, methacrylic acid, acrylic acid, 2-carboxyethyl (meth)acrylate.

Vinyl esters; for example, vinyl acetate, vinyl propionate, vinyl butyrate, vinyl caproate, vinyl caprylate, vinyl caprate, vinyl laurate, vinyl myristate, vinyl palmitate, vinyl stearate, vinyl pivalate, and vinyl octylate.

Styrene and derivatives thereof: styrene, o-methylstyrene, and the like.

(Meth)acrylic acid esters: methyl (meth)acrylate, n-butyl (meth)acrylate, t-butyl (meth)acrylate, 2-ethylhexyl (meth)acrylate, and the like.

Unsaturated polyenes: unsaturated monoolefins such as ethylene, propylene, butylene, and isobutylene; butadiene, isoprene, and the like.

Aromatic divinyl compounds: diacrylate compounds linked by alkyl chains; diacrylate compounds linked by alkyl chains containing ether bonds; diacrylate compounds linked by chains containing aromatic groups and ether bonds; polyester-type diacrylates; and polyfunctional crosslinking agents.

Examples of the aromatic divinyl compounds include divinylbenzene, divinylnaphthalene, and the like.

Examples of diacrylate compounds linked by alkyl chains include ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, and compounds in which the acrylate of the above compounds is replaced with a methacrylate.

Among these, the use of styrene and derivatives thereof such as styrene and o-methylstyrene improves hot offset resistance. More preferably, the crystalline vinyl resin contains a monomer unit corresponding to styrene. The crystalline vinyl resin contains preferably 0.0% by mass to 50.0% by mass, and more preferably 20.0% by mass to 40.0% by mass of the monomer unit corresponding to styrene.

The crystalline vinyl resin can be produced using the exemplified polymerizable monomers and polymerization initiators. From the viewpoint of efficiency, the polymerization initiator is preferably used in an amount of from 0.05 parts by mass to 10 parts by mass per 100 parts by mass of the polymerizable monomers.

Examples of the polymerization initiator include the following.
ketone peroxides such as 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobis isobutyrate, 1,1′-azobis(1-cyclohexanecarbonitrile), 2-carbamoylazoisobutyronitrile, 2,2′-azobis(2,4,4-trimethylpentane), 2-phenylazo-2,4-dimethyl-4-methoxyvaleronitrile, 2,2′-azobis(2-methylpropane), methyl ethyl ketone peroxide, acetylacetone peroxide and cyclohexanoneperoxide; as well as 2,2-bis(tert-butyl peroxy) butane, tert-butylhydroperoxide, methanehydroperoxide, 1,1,3,3-tetramethylbutylhydroperoxide, di-tert-butyl peroxide, tert-butylcumyl peroxide, dicumyl peroxide, α,α′-bis(tert-butyl peroxyisopropyl)benzene, isobutyl peroxide, octanoyl peroxide, decanoyl peroxide, lauroyl peroxide, 3,5,5-trimethylhexanoyl peroxide, benzoyl peroxide, m-trioyl peroxide, diisopropyl peroxydicarbonate, di-2-ethylhexyl peroxydicarbonate, di-n-propyl peroxydicarbonate, di-2-ethoxyethyl peroxycarbonate, dimethoxyisopropyl peroxydicarbonate, di(3-methyl-3-methoxybutyl) peroxycarbonate, acetylcyclohexylsulfonyl peroxide, tert-butyl peroxyacetate, tert-butyl peroxyisobutyrate, tert-butyl peroxyneodecanoate, tert-butyl peroxy-2-ethylhexanoate, tert-butyl peroxylaurate, tert-butyl peroxybenzoate, tert-butyl peroxyisopropyl carbonate, di-tert-butyl peroxyisophthalate, tert-butyl peroxyallyl carbonate, tert-amyl peroxy-2-ethylhexanoate, di-tert-butyl peroxyhexahydroterephthalate and di-tert-butyl peroxyazelate.

From the viewpoint of charge stability, the crystalline vinyl resin preferably has an acid value of 0 mg KOH/g to 100 mg KOH/g, and more preferably 0 mg KOH/g to 50 mg KOH/g. Similarly, the hydroxyl value is preferably 0 mg KOH/g to 100 mg KOH/g, and more preferably 0 mg KOH/g to 50 mg KOH/g.

The binder resin may include an amorphous resin. Any known amorphous resin may be used to the extent that it does not impair the effects of the present disclosure. From the viewpoint of low-temperature fixability, it is preferable that the binder resin include 30% by mass to 80% by mass of crystalline vinyl resin.

Examples of known amorphous resins include the following.

Polyvinyl chloride, phenolic resins, natural resin-modified phenolic resins, natural resin-modified maleic acid resins, polyvinyl acetate, silicone resins, polyester resins, polyurethane resins, polyamide resins, furan resins, epoxy resins, xylene resins, polyvinyl butyral, terpene resins, coumarone-indene resin, petroleum resins, and vinyl resins.

Among these, the amorphous resin preferably contains at least one resin selected from the group consisting of hybrid resins in which a vinyl resin and a polyester resin are bonded, polyester resins, and vinyl resins. The amorphous resin more preferably contains an amorphous polyester resin. The use of an amorphous polyester resin is preferable because it makes it easier to achieve both low-temperature fixability and hot offset resistance at a high level.

Polyester resins that are ordinarily used in toners can be suitably used herein as the amorphous polyester resin. Examples of the monomers used in the above polyester resin include polyhydric alcohols (dihydric, trihydric or higher alcohols), and polyvalent carboxylic acids (divalent, trivalent or higher carboxylic acids) and acid anhydrides or lower alkyl esters thereof.

Examples of the above polyhydric alcohols include those set out below.

Examples of dihydric alcohols include the following bisphenol derivatives.

Polyoxypropylene (2.2)-2,2-bis(4-hydroxyphenyl) propane, polyoxypropylene (3.3)-2,2-bis(4-hydroxyphenyl) propane, polyoxyethylene (2.0)-2,2-bis(4-hydroxyphenyl) propane, polyoxypropylene (2.0)-polyoxyethylene (2.0)-2,2-bis(4-hydroxyphenyl) propane, polyoxypropylene (6)-2,2-bis(4-hydroxyphenyl) propane and the like.

Other polyhydric alcohols include ethylene glycol, diethylene glycol, triethylene glycol, 1,2-propanediol, 1,3-propanediol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane, tritrimethylolpropane and 1,3,5-trihydroxymethylbenzene.

These polyhydric alcohols can be used singly or in combinations of a plurality thereof.

Examples of the above polyvalent carboxylic acids include those below.

Examples of divalent carboxylic acids include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenylsuccinic acid, isododecenylsuccinic acid, n-dodecylsuccinic acid, isododecylsuccinic acid, n-octenylsuccinic acid, n-octylsuccinic acid, isooctenylsuccinic acid and isooctylsuccinic acid, as well as anhydrides and lower alkyl esters of these acids. Preferably among the foregoing there is used maleic acid, fumaric acid, terephthalic acid, n-dodecenylsuccinic acid or adipic acid.

As the divalent carboxylic acid, an alkenyl succinic acid such as n-dodecenyl succinic acid, isododecenyl succinic acid, n-octenyl succinic acid, or isooctenyl succinic acid may be used. Since these alkenyl succinic acids have an alkenyl group, they are likely to interact with the long-chain alkyl units of the crystalline vinyl resin. Since this interaction is weaker than the interaction between polar groups, the filler effect is easily exhibited due to the interaction when the strain is small, but the filler effect is unlikely to be exhibited when the strain is large. As a result, the toner may may have better low-temperature fixability.

Examples of trivalent or higher carboxylic acids, anhydrides, and lower alkyl esters thereof include the following:
1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl) methane, 1,2,7,8-octanetetracarboxylic acid, pyromellitic acid, empol trimer acid, anhydrides thereof, and lower alkyl esters thereof.

Among these, 1,2,4-benzenetricarboxylic acid (trimellitic acid) and derivatives thereof such as anhydrides are preferably used because they are inexpensive and the reaction can be easily controlled.

These polyvalent carboxylic acids can be used alone or a plurality thereof may be used combination.

Also, linear saturated fatty acids such as behenic acid may be used.

The method for producing the polyester resin is not particularly limited, and a known method can be resorted to herein. For instance, a polyhydric alcohol and a polyvalent carboxylic acid described above are simultaneously charged, and are polymerized as a result of an esterification reaction or a transesterification reaction, and a condensation reaction, to produce a polyester resin. The polymerization temperature is not particularly limited, but lies preferably in the range from 180° C. to 290° C. For instance a polymerization catalyst such as a titanium-based catalyst, a tin-based catalyst, zinc acetate, antimony trioxide or germanium dioxide can be used in polymerization of polyester resins.

The polyester resin used in the amorphous resin is preferably obtained through condensation polymerization using at least one from among a titanium-based catalyst and a tin-based catalyst.

Examples of amorphous vinyl resins used as amorphous resins include polymers of polymerizable monomers containing ethylenically unsaturated bonds. The term ethylenically unsaturated bond denotes a carbon-carbon double bond capable of undergoing radical polymerization, and may be for instance a vinyl group, a propenyl group, an acryloyl group or a methacryloyl group.

Examples of polymerizable monomers include the following.

Styrenic monomers such as styrene, o-methylstyrene, m-methylstyrene, p-methylstyrene, p-phenylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxy styrene, p-chlorostyrene, 3,4-dichlorostyrene, m-nitrostyrene, o-nitrostyrene, p-nitrostyrene;
acrylic acids and acrylic acid esters such as acrylic acid, methyl acrylate, ethyl acrylate, propyl acrylate, n-butyl acrylate, isobutyl acrylate, n-octyl acrylate, dodecyl acrylate, 2-ethylhexyl acrylate, stearyl acrylate, 2-chloroethyl acrylate and phenyl acrylate;
methacrylic acids and methacrylic acid esters such as methacrylic acid, methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate and diethylaminoethyl methacrylate;
as well as acrylonitrile, methacrylonitrile and acrylamide.

Further examples include acrylic acid esters or methacrylic acid esters such as 2-hydroxyethyl acrylate, 2-hydroxyethyl methacrylate, 2-hydroxypropyl methacrylate, as well as polymerizable monomers having a hydroxy group, such as 4-(1-hydroxy-1-methylbutyl) styrene and 4-(1-hydroxy-1-methylhexyl) styrene. The foregoing can be used singly or in combinations of a plurality of types thereof.

Among these, styrene, acrylic acid esters, methacrylic acid esters, acrylonitrile, and the like are preferred. Also, monomers that are condensates of acrylic acid or methacrylic acid with alcohols having 6 to 22 carbon atoms, such as n-octyl acrylate, dodecyl acrylate, 2-ethylhexyl acrylate, stearyl acrylate, n-octyl methacrylate, dodecyl methacrylate, 2-ethylhexyl methacrylate, and stearyl methacrylate, may be used. These monomers tend to interact with the long-chain alkyl units of the crystalline vinyl resin. Since this interaction is weaker than the interaction between polar groups, the filler effect is easily exhibited due to the interaction when the strain is small, but the filler effect is unlikely to be exhibited when the strain is large. As a result, the toner may have better low-temperature fixability.

Besides the above resins, various polymerizable monomers that are amenable to vinyl polymerization may be used concomitantly, as needed, in the amorphous vinyl resin.

Examples of such polymerizable monomers include the following.

Unsaturated monoolefins such as ethylene, propylene, butylene and isobutylene; unsaturated polyenes such as butadiene and isoprene; vinyl halides such as vinyl chloride, vinylidene chloride, vinyl bromide and vinyl fluoride; vinyl esters such as vinyl acetate, vinyl propionate and vinyl benzoate; vinyl ethers such as vinyl methyl ether, vinyl ethyl ether and vinyl isobutyl ether; vinyl ketones such as vinyl methyl ketone, vinyl hexyl ketone and methyl isopropenyl ketone; N-vinyl compounds such as N-vinylpyrrole, N-vinylcarbazole, N-vinylindole and N-vinylpyrrolidone; vinylnaphthalenes; as well as polymerizable monomers having a carboxy group, for instance unsaturated dibasic acids such as maleic acid, citraconic acid, itaconic acid, alkenylsuccinic acids, fumaric acid and mesaconic acid; unsaturated dibasic anhydrides such as maleic anhydride, citraconic anhydride, itaconic anhydride and alkenylsuccinic anhydrides; half esters of unsaturated dibasic acids such as methyl maleate half ester, ethyl maleate half ester, butyl maleate half ester, methyl citraconate half ester, ethyl citraconate half ester, butyl citraconate half ester, methyl itaconate half ester, methyl alkenylsuccinate half esters, methyl fumarate half ester and methyl mesaconate half ester; unsaturated basic acid esters such as maleic acid dimethyl ester and fumaric acid dimethyl ester; acid anhydrides of α,β-unsaturated acids such as acrylic acid, methacrylic acid, crotonic acid and cinnamic acid; anhydrides of these α,β-unsaturated acids and lower fatty acids; alkenyl malonic acids, alkenyl glutaric acids and alkenyl adipic acids; as well as acid anhydrides of the foregoing, and monoesters of the foregoing.

As the case may require, the amorphous vinyl resin may be a polymer crosslinked with a crosslinking polymerizable monomer such as those exemplified below.

Examples of the crosslinking polymerizable monomer include the following.

Aromatic divinyl compounds; diacrylate compounds having an alkyl chain bridge; diacrylate compounds having an alkyl chain bridge containing an ether bond; diacrylate compounds having a bridge of a chain containing an aromatic group and an ether bond; polyester-type diacrylates; and multifunctional crosslinking agents.

Examples of aromatic divinyl compounds include divinylbenzene and divinylnaphthalene.

Examples of the above diacrylate compounds having an alkyl chain bridge include ethylene glycol diacrylate, 1,3-butylene glycol diacrylate, 1,4-butanediol diacrylate, 1,5-pentanediol acrylate, 1,6-hexanediol diacrylate, neopentyl glycol diacrylate, and compounds resulting from replacing the acrylate in the foregoing compounds with methacrylate.

The amorphous vinyl resin is preferably a polymer of polymerizable monomers including at least one selected from the group consisting of styrene, o-methylstyrene, m-methylstyrene, p-methylstyrene, p-phenylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, p-chlorostyrene, 3,4-dichlorostyrene, m-nitrostyrene, o-nitrostyrene, p-nitrostyrene, acrylic acid, methyl acrylate, ethyl acrylate, propyl acrylate, n-butyl acrylate, isobutyl acrylate, n-octyl acrylate, dodecyl acrylate, 2-ethylhexyl acrylate, stearyl acrylate, 2-chloroethyl acrylate, phenyl acrylate, methacrylic acid, methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, diethylaminoethyl methacrylate, acrylonitrile, methacrylonitrile, acrylamide, 2-hydroxyethyl acrylate, 2-hydroxyethyl methacrylate, 2-hydroxypropyl methacrylate, 4-(1-hydroxy-1-methylbutyl) styrene and 4-(1-hydroxy-1-methylhexyl) styrene.

The amorphous vinyl resin may be a copolymer of at least one polymerizable monomer selected from the above group, and a monomer including at least one crosslinking polymerizable monomer selected from the group consisting of divinylbenzene, divinylnaphthalene, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, ethylene glycol dimethacrylate, 1,3-butylene glycol dimethacrylate, 1,4-butanediol dimethacrylate, 1,5-pentanediol dimethacrylate, 1,6-hexanediol dimethacrylate and neopentyl glycol dimethacrylate. The content ratio of the crosslinking monomer among the monomers may be set to from about 0.5 mass % to 5.0 mass %.

The amorphous vinyl resin may be a resin produced using a polymerization initiator. From the viewpoint of efficiency, the polymerization initiator may be used in an amount from 0.05 parts by mass to 10 parts by mass relative to 100 parts by mass of the polymerizable monomers. Examples of the polymerization initiator include the following.

ketone peroxides such as 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobis isobutyrate, 1,1′-azobis(1-cyclohexanecarbonitrile), 2-carbamoylazoisobutyronitrile, 2,2′-azobis(2,4,4-trimethylpentane), 2-phenylazo-2,4-dimethyl-4-methoxyvaleronitrile, 2,2′-azobis(2-methylpropane), methyl ethyl ketone peroxide, acetylacetone peroxide and cyclohexanoneperoxide; as well as 2,2-bis(tert-butyl peroxy) butane, tert-butylhydroperoxide, methanehydroperoxide, 1,1,3,3-tetramethylbutylhydroperoxide, di-tert-butyl peroxide, tert-butylcumyl peroxide, dicumyl peroxide, α,α′-bis(tert-butyl peroxyisopropyl)benzene, isobutyl peroxide, octanoyl peroxide, decanoyl peroxide, lauroyl peroxide, 3,5,5-trimethylhexanoyl peroxide, benzoyl peroxide, m-trioyl peroxide, diisopropyl peroxydicarbonate, di-2-ethylhexyl peroxydicarbonate, di-n-propyl peroxydicarbonate, di-2-ethoxyethyl peroxycarbonate, dimethoxyisopropyl peroxydicarbonate, di(3-methyl-3-methoxybutyl) peroxycarbonate, acetylcyclohexylsulfonyl peroxide, tert-butyl peroxyacetate, tert-butyl peroxyisobutyrate, tert-butyl peroxyneodecanoate, tert-butyl peroxy-2-ethylhexanoate, tert-butyl peroxylaurate, tert-butyl peroxybenzoate, tert-butyl peroxyisopropyl carbonate, di-tert-butyl peroxyisophthalate, tert-butyl peroxyallyl carbonate, tert-amyl peroxy-2-ethylhexanoate, di-tert-butyl peroxyhexahydroterephthalate and di-tert-butyl peroxyazelate.

The same vinyl resins and polyester resins used as the above-described amorphous resin can be utilized herein as the vinyl resin and polyester resin that are used to form a hybrid resin in which the vinyl resin and the polyester resin are bonded to each other.

Examples of the method for producing a hybrid resin in which a vinyl resin and a polyester resin are bonded to each other include for instance a polymerization method that utilizes a compound (hereafter “bireactive compound”) that can react with any of the monomers that generate both resins.

Examples of the bireactive compounds include compounds such as fumaric acid, acrylic acid, methacrylic acid, citraconic acid, maleic acid, and dimethyl fumarate from among the monomers of the condensation polymerization resin or the monomers of the addition polymerization resin. Of these, fumaric acid, acrylic acid, and methacrylic acid are preferably used.

In a case where a hybrid resin is used in which a vinyl resin and a polyester resin are bonded to each other, the content ratio of the vinyl resin in the hybrid resin is preferably 10 mass % or more, 20 mass % or more, 40 mass % or more, 60 mass % or more or 80 mass % or more, and preferably 100 mass % or less, or 90 mass % or less.

### Colorant

The toner particles may contain a colorant. Examples of colorants include the following.

Examples of black colorants include carbon black; and materials that are colored black through use of yellow colorants, magenta colorants and cyan colorants. The colorant may be a single pigment, but using a colorant obtained by combining a dye and a pigment and improving the clarity is more preferred from the perspective of full color image quality.

Examples of a pigment for a magenta toner include the following.

C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, 282; C. I. Pigment Violet 19; C. I. Vat Red 1, 2, 10, 13, 15, 23, 29, 35.

Examples of a dye for a magenta toner include the following.

Oil-soluble dyes such as C. I. Solvent Red 1, 3, 8, 23, 24, 25, 27, 30, 49, 81, 82, 83, 84, 100, 109, 121; C. I. Disperse Red 9; C. I. Solvent Violet 8, 13, 14, 21, 27; C. I. Disperse Violet 1, Basic dyes such as C. I. Basic Red 1, 2, 9, 12, 13, 14, 15, 17, 18, 22, 23, 24, 27, 29, 32, 34, 35, 36, 37, 38, 39, 40; C. I. Basic Violet 1, 3, 7, 10, 14, 15, 21, 25, 26, 27, 28.

Examples of a pigment for a cyan toner include the following.

C. I. Pigment Blue 2, 3, 15:2, 15:3, 15:4, 16, 17; C. I. Vat Blue 6; C. I. Acid Blue 45, a copper phthalocyanine pigment having a phthalocyanine skeleton substituted with 1 to 5 phthalimidomethyl groups.

Examples of a dye for a cyan toner include C. I. Solvent Blue 70.

Examples of a pigment for a yellow toner include the following.

C. I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, 185; C. I. Vat Yellow 1, 3, 20.

Examples of a dye for a yellow toner include C. I. Solvent Yellow 162.

The content of the colorant is preferably 0.1 parts by mass to 30.0 parts by mass per 100 parts by mass of the binder resin.

### Release Agent

The toner particle preferably contains a wax as a release agent. Examples of the wax include those listed below. Hydrocarbon-based waxes such as microcrystalline waxes, paraffin waxes and Fischer Tropsch waxes; oxides of hydrocarbon-based waxes, such as oxidized polyethylene waxes, and block copolymers thereof; waxes comprising mainly fatty acid esters, such as carnauba wax; and waxes obtained by partially or wholly deoxidizing fatty acid esters, such as deoxidized carnauba wax.

Further examples include the types listed below. Saturated straight chain fatty acids such as palmitic acid, stearic acid and montanic acid; unsaturated fatty acids such as brassidic acid, eleostearic acid and parinaric acid; saturated alcohols such as stearyl alcohol, aralkyl alcohols, behenyl alcohol, carnaubyl alcohol, ceryl alcohol and melissyl alcohol; polyhydric alcohols such as sorbitol; esters of fatty acids such as palmitic acid, stearic acid, behenic acid and montanic acid and alcohols such as stearyl alcohol, aralkyl alcohols, behenyl alcohol, carnaubyl alcohol, ceryl alcohol and melissyl alcohol; fatty acid amides such as linoleic acid amide, oleic acid amide and lauric acid amide; saturated fatty acid bisamides such as methylene bis-stearic acid amide, ethylene bis-capric acid amide, ethylene bis-lauric acid amide and hexamethylene bis-stearic acid amide; unsaturated fatty acid amides such as ethylene bis-oleic acid amide, hexamethylene bis-oleic acid amide, N,N′-dioleyladipic acid amide and N,N′-dioleylsebacic acid amide; aromatic bisamides such as m-xylene bis-stearic acid amide and N,N′-distearylisophthalic acid; fatty acid metal salts (commonly known as metal soaps) such as calcium stearate, calcium laurate, zinc stearate and magnesium stearate; waxes obtained by grafting vinyl monomers such as styrene and acrylic acid onto aliphatic hydrocarbon-based waxes; partial esters of fatty acids and polyhydric alcohols, such as behenic acid monoglyceride; and hydroxyl group-containing methyl ester compounds obtained by hydrogenating plant-based oils and fats.

The content of the wax is preferably 2.0 to 30.0 parts by mass relative to 100 parts by mass of the binder resin.

### Charge Control Agent

The toner particle may contain a charge control agent if necessary. A well-known charge control agent can be used, but an aromatic carboxylic acid metal compound is particularly preferred from the perspectives of being colorless, toner charging speed being rapid, and being able to stably maintain a certain degree of charge quantity.

Examples of negative type charge control agents include metal salicylate compounds, metal naphthoate compounds, metal dicarboxylate compounds, polymer type compounds having a sulfonic acid or carboxylic acid in a side chain, polymer type compounds having a sulfonic acid salt or sulfonic acid ester in a side chain, polymer type compounds having a carboxylic acid salt or carboxylic acid ester in a side chain, boron compounds, urea compounds, silicon compounds and calixarenes.

The charge control agent may be internally or externally added to the toner particle. The content of the charge control agent is preferably 0.2 to 10.0 parts by mass relative to 100 parts by mass of the binder resin.

### External Additive

The toner may contain a toner particle and an external additive. As the external additive, inorganic fine particles such as silica, titanium oxide, aluminum oxide, and metal titanate are preferable. The inorganic fine particles are preferably hydrophobized with a hydrophobizing agent such as a silane compound, silicone oil, or a mixture thereof.

As the external additive for improving flowability, inorganic fine particles having a specific surface area from 50 m²/g to 400 m²/g are preferable, and for stabilizing durability, inorganic fine particles having a specific surface area from 10 m²/g to 50 m²/g are preferable. In order to achieve both improved flowability and stabilized durability, inorganic fine particles having a specific surface area within the above range may be used in combination. The toner particles and the external additive may be mixed using a known mixer such as a Henschel mixer.

The content of the external additive is preferably 0.1 parts by mass to 10.0 parts by mass, and more preferably 1.0 parts by mass to 5.0 parts by mass based on 100 parts by mass of the toner particles.

### Developer

The toner can be used as a one-component developer, but is preferably mixed with a magnetic carrier and used as a two-component developer, in terms of obtaining stable images over long periods of time. Specifically, the developer is herein a two-component developer containing a toner and a magnetic carrier, such that the toner is the above-described toner.

Examples of magnetic carriers include generally known ones such as an iron powder or a surface-oxidized iron powder; metal particles of iron, lithium, calcium, magnesium, nickel, copper, zinc, cobalt, manganese, chromium, rare earths or the like, as well as alloy particles thereof and oxide particles thereof; magnetic bodies such as ferrite; and magnetic body-dispersed resin carriers (so-called resin carriers) containing one such magnetic body and a binder resin that holds the magnetic body in a dispersed state.

In a case where the toner is mixed with a magnetic carrier and used as a two-component developer, the content ratio of the toner in the two-component developer is preferably from 2 mass % to 15 mass %, more preferably from 4 mass % to 13 mass %.

### Toner Production Method

A toner production method is not particularly limited, and known methods such as pulverization, suspension polymerization, dissolution suspension, emulsion aggregation, and dispersion polymerization can be used. The toner is preferably manufactured by the emulsion aggregation method. In other words, the toner particles are preferably emulsion aggregation toner particles.

### Emulsion Aggregation Method

In the emulsion aggregation method, an aqueous dispersion solution of fine particles which are sufficiently smaller than the desired particle size and consist of a constituent material of toner particles is prepared in advance, the fine particles are aggregated to the particle size of toner particles in an aqueous medium, and the resin is fused by heating or the like to produce toner particles.

That is, in the emulsion aggregation method, toner particles are produced through a dispersion step of preparing a fine particle-dispersed solution consisting of the constituent material of the toner particles, an aggregation step of aggregating the fine particles consisting of the constituent material of the toner particles, and controlling the particle diameter until the particle diameter of the toner particles is obtained, a fusion step of fusing the resin contained in the obtained aggregated particles, a subsequent cooling step, a metal removal step of filtering off the obtained toner and removing excess polyvalent metal ions, a filtration and washing step of washing with ion exchanged water or the like, and a step of removing moisture of the washed toner particles and drying.

### Step of Preparing Resin Fine Particle-Dispersed Solution (Dispersion Step)

The resin fine particle-dispersed solution can be prepared by known methods, but is not limited to these methods. Examples of the known methods include an emulsion polymerization method, a self-emulsification method, a phase inversion emulsification method of emulsifying a resin by adding an aqueous medium to a resin solution obtained by dissolving the resin in an organic solvent, and a forced emulsification method in which the resin is forcedly emulsified by high-temperature treatment in an aqueous medium, without using an organic solvent.

Specifically, a binder resin is dissolved in an organic solvent that can dissolve the resin, and a surfactant or a basic compound is added. At that time, where the binder resin is a crystalline resin having a melting point, the resin may be dissolved by melting to a temperature higher than the melting point. Subsequently, an aqueous medium is slowly added to precipitate resin fine particles while stirring with a homogenizer or the like. Thereafter, the solvent is removed by heating or depressurizing to prepare a resin fine particle-dispersed aqueous solution. Any organic solvent that can dissolve the resin can be used as the organic solvent for dissolving the resin, but an organic solvent which forms a homogeneous phase with water, such as toluene, is preferable from the viewpoint of suppressing the generation of coarse powder.

A surfactant to be used at the time of the emulsification is not particularly limited, and examples thereof include anionic surfactants such as sulfuric acid esters, sulfonic acid salts, carboxylic acid salts, phosphoric acid esters, soaps and the like; cationic surfactants such as amine salts, quaternary ammonium salts and the like; and nonionic surfactants such as polyethylene glycol, alkylphenol ethylene oxide adducts, polyhydric alcohols and the like. The surfactants may be used singly or in combination of two or more thereof.

Examples of the basic compound to be used in the dispersion step include inorganic bases such as sodium hydroxide, potassium hydroxide and the like, and organic bases such as ammonia, triethylamine, trimethylamine, dimethylaminoethanol, diethylaminoethanol and the like. The basic compounds may be used singly or in combination of two or more thereof.

The 50% particle diameter (D50), based on the volume distribution, of the fine particles of the binder resin in the resin fine particle-dispersed aqueous solution is preferably 0.05 μm to 1.0 μm, and more preferably 0.05 μm to 0.4 μm. By adjusting the 50% particle diameter (D50) based on the volume distribution to the above range, it is easy to obtain toner particles with a volume average particle diameter of 3 μm to 10 μm which is suitable for toner particles.

A dynamic light scattering type particle size distribution analyzer NANOTRAC UPA-EX150 (manufactured by Nikkiso Co., Ltd.) is used for measurement of the 50% particle size (D50) based on the volume distribution.

### Colorant Fine Particle-Dispersed Solution

The colorant fine particle-dispersed solution, which is used as necessary, can be prepared by the known methods listed below, but is not limited to these methods. The colorant fine particle-dispersed solution can be prepared by mixing a colorant, an aqueous medium and a dispersing agent by using a mixer such as a known stirrer, emulsifier, and disperser. The dispersing agent used here may be a known one such as a surfactant and a polymer dispersing agent.

Although any of the surfactant and the polymer dispersing agent can be removed in the washing step described hereinbelow, the surfactant is preferable from the viewpoint of washing efficiency.

Examples of the surfactant include anionic surfactants such as sulfuric acid esters, sulfonic acid salts, carboxylic acid salts, phosphoric acid esters, soaps and the like; cationic surfactants such as amine salts, quaternary ammonium salts and the like; and nonionic surfactants such as polyethylene glycol, alkylphenol ethylene oxide adducts, polyhydric alcohols and the like.

Among these, nonionic surfactants and anionic surfactants are preferable. Moreover, a nonionic surfactant and an anionic surfactant may be used together. The surfactants may be used singly or in combination of two or more thereof. The concentration of the surfactant in the aqueous medium is preferably 0.5% by mass to 5% by mass.

The amount of the colorant fine particles in the colorant fine particle-dispersed solution is not particularly limited, but is preferably 1% by mass to 30% by mass with respect to the total mass of the colorant fine particle-dispersed solution.

In addition, from the viewpoint of dispersibility of the colorant in the finally obtained toner, the dispersed particle diameter of the colorant fine particles in the colorant fine particle-dispersed aqueous solution is preferably such that the 50% particle diameter (D50) based on the volume distribution is 0.5 μm or less. Further, for the same reason, it is preferable that the 90% particle size (D90) based on the volume distribution be 2 μm or less. The dispersed particle diameter of the colorant particles dispersed in the aqueous medium is measured by a dynamic light scattering type particle size distribution analyzer (NANOTRAC UPA-EX150: manufactured by Nikkiso Co., Ltd.).

Known mixers such as stirrers, emulsifiers, and dispersers used for dispersing colorants in aqueous media include ultrasonic homogenizers, jet mills, pressure homogenizers, colloid mills, ball mills, sand mills, and paint shakers. These may be used singly or in combination.

### Release Agent (Aliphatic Hydrocarbon Compound) Fine Particle-Dispersed Solution

A release agent fine particle-dispersed solution may be used as necessary. The release agent fine particle-dispersed solution can be prepared by the following known methods, but is not limited to these methods.

The release agent fine particle-dispersed solution can be prepared by adding a release agent to an aqueous medium including a surfactant, heating to a temperature equal to or higher than the melting point of the release agent, dispersing to a particulate shape with a homogenizer having a strong shearing ability (for example, “CLEARMIX W MOTION” manufactured by M Technique Co., Ltd.) or a pressure discharge type disperser (for example, a “GAULIN HOMOGENIZER” manufactured by Gaulin Co., Ltd.) and then cooling to below the melting point.

The dispersed particle diameter of the release agent fine particle-dispersed solution in the release agent-dispersed aqueous solution is preferably such that the 50% particle diameter (D50) based on volume distribution is 0.03 μm to 1.0 μm, and more preferably, 0.1 μm to 0.5 μm. In addition, it is preferable that coarse particles of 1 μm or more be not present.

When the dispersed particle diameter of the release agent fine particle-dispersed solution is within the above range, the release agent can be finely dispersed to be present in the toner, the seeping effect at the time of fixing can be maximized, and it is possible to obtain good separability. The dispersed particle diameter of the release agent fine particle-dispersed solution obtained by dispersion in an aqueous medium can be measured with a dynamic light scattering type particle size distribution analyzer (NANOTRAC UPA-EX 150: manufactured by Nikkiso Co., Ltd.).

### Mixing Step

In the mixing step, a mixed liquid is prepared by mixing, if necessary, the resin fine particle-dispersed solution with at least one of the release agent fine particle-dispersed solution and the colorant fine particle-dispersed solution. The mixing can be carried out using a known mixing device such as a homogenizer and a mixer.

### Step of Forming Aggregated Particles (Aggregation Step)

In the aggregation step, fine particles contained in the mixed liquid prepared in the mixing step are aggregated to form aggregates having a target particle diameter. At this time, a flocculant is added and mixed, and if necessary, at least one of heating and mechanical power is appropriately added to form aggregates in which fine resin particles and, if necessary, at least one of the release agent fine particles and the colorant fine particles are aggregated.

The flocculant is a flocculant including metal ions of a polyvalent metal, and the polyvalent metal is at least one selected from the group consisting of Mg, Ca, Al, and Zn.

The content ratio of the polyvalent metal in the toner particle can be controlled by the amount of flocculant containing metal ions of polyvalent metal added. The amount of flocculant added is not particularly limited, and the content ratio of polyvalent metal in the toner particle may be in the range of 25 ppm by mass to 500 ppm by mass.

The flocculant containing metal ions of the polyvalent metal has high flocculation power, and it is possible to achieve the purpose by adding a small amount of the flocculant. Such flocculants can ionically neutralize the ionic surfactants contained in the resin fine particle dispersion liquid, release agent fine particle dispersion liquid, and colorant fine particle dispersion liquid. As a result, the binder resin fine particles, release agent fine particles, and colorant fine particles are flocculated by the effects of salting out and ionic crosslinking. Furthermore, the flocculant containing the metal ions of the polyvalent metal can be uniformly dispersed in the toner particle. Furthermore, where the crystalline vinyl resin has a polar group, the metal ions can interact with the polar group, resulting in better charge diffusion property and effectively suppressing image sticking.

The flocculant including metal ions of a polyvalent metal can be exemplified by metal salts of polyvalent metals and polymers of the metal salts. Specific examples include divalent inorganic metal salts such as calcium chloride, calcium nitrate, magnesium chloride, magnesium sulfate and zinc chloride. Other examples include trivalent metal salts such as iron (III) chloride, iron (III) sulfate, aluminum sulfate, and aluminum chloride. In addition, inorganic metal salt polymers such as polyaluminum chloride, polyaluminum hydroxide and calcium polysulfide may be mentioned, but these examples are not limiting. These may be used singly or in combination of two or more thereof.

The flocculant may be added in the form of a dry powder or an aqueous solution obtained by dissolving in an aqueous medium, but in order to cause uniform aggregation, the flocculant is preferably added in the form of an aqueous solution.

Moreover, it is preferable to perform addition and mixing of the flocculant at a temperature equal to or lower than the glass transition temperature or melting point of the resin contained in a mixed liquid. By performing mixing under such temperature condition, the aggregation proceeds relatively uniformly. The mixing of the flocculant into the mixed liquid can be carried out using known mixing devices such as homogenizers and mixers. The aggregation step is a step of forming aggregates of a toner particle size in an aqueous medium. The volume average particle size of the aggregates produced in the aggregation step is preferably 3 μm to 10 μm. The volume average particle diameter can be measured by a particle size distribution analyzer (Coulter Multisizer III: manufactured by Beckman Coulter, Inc.) by the Coulter method.

Step of Obtaining Dispersion solution Including Toner Particles (Fusion Step)

In the fusion step, an aggregation stopper may be added to the dispersion solution including the aggregates obtained in the aggregation step under stirring similar to that in the aggregation step. The aggregation stopper can be exemplified by a chelating agent that stabilizes aggregated particles by partially dissociating the ionic crosslinks between the acidic polar group of the surfactant and the metal ion that is the flocculant and forming a coordination bond with the metal ion.

After the dispersion state of the aggregated particles in the dispersion solution has been stabilized by the action of the aggregation stopper, the aggregated particles are fused by heating to a temperature equal to or higher than the glass transition temperature or melting point of the binder resin.

The chelating agent is not particularly limited as long as it is a known water-soluble chelating agent. Specific examples include hydroxycarboxylic acids such as tartaric acid, citric acid and gluconic acid, and sodium salts thereof; iminodiacid (IDA), nitrilotriacetic acid (NTA), and ethylenediaminetetraacetic acid (EDTA), and sodium salts of these acids.

The chelating agent is coordinated to the metal ion of the flocculant present in the dispersion solution of the aggregated particles, so that the environment in the dispersion solution can be changed from an electrostatically unstable state in which aggregation can easily occur to an electrostatically stable state in which further aggregation is unlikely to occur. As a result, it is possible to suppress further aggregation of the aggregated particles in the dispersion solution and to stabilize the aggregated particles.

The chelating agent is preferably an organic metal salt having a carboxylic acid having a valency of 3 or more, since even small amounts of such chelating agent can be effective and toner particles having a sharp particle size distribution can be obtained.

Further, from the viewpoint of achieving both stabilization from the aggregation state and washing efficiency, the addition amount of the chelating agent is preferably 1 part by mass to 30 parts by mass and more preferably 2.5 parts by mass to 15 parts by mass with respect to 100 parts by mass of the binder resin. The volume-based 50% particle diameter (D50) of the toner particles is preferably 3 μm to 10 μm.

### Step of Promoting Crystallization

In order to increase the degree of crystallization of a crystalline material such as a crystalline vinyl resin, an annealing treatment may be performed near the crystallization temperature of the crystalline material (for example, in the range of the crystallization temperature ±10° C., and preferably in the range of the crystallization temperature ±5° C.). The preferred range of holding time is 30 min or more, more preferably 60 min or more, and even more preferably 100 min or more. The upper limit of the holding time is approximately 24 h or less in terms of production efficiency.

### Cooling Step

If necessary, in the cooling step, the temperature of the dispersion solution including the toner particles obtained in the fusion step can also be reduced to a temperature lower than at least one of the crystallization temperature and glass transition temperature of the binder resin. By cooling to a temperature lower than at least one of the crystallization temperature and glass transition temperature, it is possible to prevent the generation of coarse particles. The specific cooling rate can be 0.1° C./min to 50° C./min.

### Washing Step

If necessary, impurities in the toner particles can be removed by repeating the washing and filtration of the toner particles obtained in the cooling step in the washing step. Specifically, it is preferable to wash the toner particles by using an aqueous solution including a chelating agent such as ethylenediaminetetraacetic acid (EDTA) and a Na salt thereof, and further wash with pure water. By repeating washing with pure water and filtration a plurality of times, metal salts and surfactants in the toner particles can be removed. The number of filtrations is preferably 3 to 20 and more preferably 3 to 10 from the viewpoint of production efficiency.

### Drying Step

In the drying step, if necessary, the toner particles obtained in the above step are dried.

### External Addition Step

In the external addition step, if necessary, inorganic fine particles are externally added to the toner particles obtained in the drying step. Specifically, it is preferable to add inorganic fine particles such as silica or resin fine particles of a vinyl resin, a polyester resin, or a silicone resin while applying a shear force in a dry state.

Methods for measuring various physical properties of toner and raw materials will be described hereinbelow.

### Method for Measuring Amount of Metals in Toner Particle

The amount of metals in the toner particle is measured using a multi-element simultaneous ICP emission spectrophotometer Vista-PRO (manufactured by Hitachi High-Tech Science Co., Ltd.).
Sample: 50 mg
Solvent: 6 mL of nitric acid

The above materials are weighed, and decomposition processing is performed using a microwave sample pretreatment device ETHOS UP (manufactured by Milestone General Co., Ltd.).

Temperature: raised from 20° C. to 230° C. and held at 230° C. for 30 min.

The decomposition solution is passed through filter paper (5C), transferred to a 50 mL volumetric flask, and made up to 50 mL with ultrapure water. The amount of polyvalent metal elements (such as Mg, Ca, Al, and Zn) in the toner particle can be quantified by measuring the aqueous solution in the volumetric flask under the following conditions with the multi-element simultaneous ICP emission spectrophotometer Vista-PRO. For quantification of the amount, a calibration curve is prepared using a standard sample of the element to be quantified, and the calculation is performed based on the calibration curve.
Condition: RF power 1.20 kW,
Ar gas: plasma flow 15.0 L/min,
Auxiliary flow: 1.50 L/min,
MFC: 1.50 L/min,
Nevizer Flow: 0.90 L/min,
Pump speed: 15 rpm,
Measurement repetition: 3 times,
Measurement time: 1.0 s

When Measuring Toner to Which Inorganic Fine Particles Containing at Least One Metal Selected from the Group Consisting of Mg, Ca, Al, and Zn are Added

When measuring the metal content in a toner particle contained in a toner to which inorganic fine particles containing at least one metal selected from the group consisting of Mg, Ca, Al, and Zn are added, the inorganic fine particles are separated from the toner before measurement in order to prevent the calculation of the metal content derived from the inorganic fine particles other than the polyvalent metal in the toner particle.

Method for Separating Inorganic Fine Particles from Toner

The inorganic fine particles can be separated from the toner by utilizing the difference in solubility of the materials contained in the toner in the solvent.

The toner is dissolved in methyl ethyl ketone (MEK) at 100° C., and the soluble matter (crystalline vinyl resin, amorphous resin other than the crystalline vinyl resin, release agent) and the insoluble matter (colorant, inorganic fine particles, and the like) are separated. The amount of polyvalent metal in the toner particle can be measured by measuring the soluble and insoluble matters obtained.

Method for Separating Toner Particles from Toner

When analyzing toner particles, where the surface of the toner particles has been treated with an external additive, the external additive is separated by the following method to obtain toner particles.

A total of 160 g of sucrose (manufactured by Kishida Chemical Co., Ltd.) is added to 100 mL of ion-exchanged water and dissolved using a hot water bath to prepare a concentrated sucrose solution. A total of 31 g of the concentrated sucrose solution and 6 mL of Contaminon N (a 10% aqueous solution of a neutral detergent for cleaning precision measuring instruments that has pH 7 and consists of a nonionic surfactant, an anionic surfactant, and an organic builder, manufactured by Wako Pure Chemical Industries, Ltd.) are added to a centrifuge tube to prepare a dispersion liquid.

A total of 1.0 g of toner is added to this dispersion, and the toner lumps are broken with a spatula or the like. The centrifuge tube is shaken with a shaker (AS-IN, sold by AS ONE Corporation) at 350 spm (strokes per minute) for 20 min. After shaking, the solution is transferred to a glass tube for a swing rotor (50 mL) and separated in a centrifuge (H-9R, manufactured by Kokusan Co., Ltd.) at 3500 rpm for 30 min. This operation separates the toner particles from the removed external additives.

The separation of toner particles and the aqueous solution is visually confirmed to be sufficient, and the toner particles separated in the top layer are collected with a spatula or the like. The collected toner is filtered through a vacuum filter and then dried in a dryer for 1 h or more to obtain toner particles. This operation is carried out multiple times to ensure the required amount.

Method for Separating Crystalline Vinyl Resin and Amorphous Resin from Toner Particle

Separation of the crystalline vinyl resin and the amorphous resin from the toner particle can be achieved by known methods, an example of which is shown below.

Gradient LC is used as a method for separating resin components from toner particles. In this analysis, separation can be achieved according to the polarity of the resins in the binder resin, regardless of molecular weight.

First, the toner particles are dissolved in chloroform. The sample is adjusted to a sample concentration of 0.1% by mass in chloroform, and the solution is filtered through a 0.45 μm PTFE filter and used for measurement. The gradient polymer LC measurement conditions are as follows:
Apparatus: UltiMate 3000 (manufactured by Thermo Fisher Scientific Inc.)
Mobile phase: A chloroform (HPLC), B acetonitrile (HPLC)
Gradient: 2 min (A/B=0/100)→25 min (A/B=100/0)
(The gradient of the mobile phase change is set to be linear.)
Flow rate: 1.0 mL/min
Injection: 0.1% by mass×20 μL
Column: Tosoh TSKgel ODS (4.6 mm diameter×150 mm×5 μm)
Column temperature: 40° C.
Detector: Corona Charged Aerosol Detector (Corona-CAD) (manufactured by Thermo Fisher Scientific Inc.)

The resin components can be separated into two peaks according to polarity in the time-intensity graph obtained by the measurement. After that, the above measurement is performed again, and separation into two types of resin can be performed by taking out the fractions at the time when the valleys of the respective peaks are reached. The separated resins are subjected to DSC measurement, and the resin with a melting point peak is taken as the crystalline vinyl resin (A) (mass W11 [g]), and the resin without a melting point peak is taken as the amorphous resin (mass W12 [g]).

Where a release agent is contained in the toner particle, it is necessary to separate the release agent from the toner particle in advance. The release agent is separated by recycling HPLC, and components with a molecular weight of 3000 or less are separated as the release agent. The molecular weight at the time of separation can be changed depending on the molecular weight of the release agent. The measurement method is as follows.

First, a chloroform solution of the toner is prepared using the method described above. The resulting solution is then filtered through a solvent-resistant membrane filter “MyShori Disc” (manufactured by Tosoh Corporation) with a pore size of 0.2 μm to obtain a sample solution. The sample solution is adjusted so that the concentration of components soluble in chloroform is 1.0% by mass. This sample solution is used for measurements under the following conditions.
Apparatus: LC-Sakura NEXT (manufactured by Japan Analytical Industry Co., Ltd.)
Column: JAIGEL 2H, 4H (manufactured by Japan Analytical Industry Co., Ltd.)
Eluent: chloroform
Flow rate: 10.0 mL/min
Oven temperature: 40.0° C.
Sample injection amount: 1.0 mL

To calculate the molecular weight of the sample, a molecular weight calibration curve created using standard polystyrene resin (for example, product names “TSK Standard Polystyrene F-850, F-450, F-288, F-128, F-80, F-40, F-20, F-10, F-4, F-2, F-1, A-5000, A-2500, A-1000, and A-500”, manufactured by Tosoh Corporation) is used. From the molecular weight curve thus obtained, the components with a molecular weight of 3000 or less are repeatedly separated, and the release agent (mass W3 [g]) is removed from the toner particles.

### Measurement of Content Ratio of Each Component in Toner Particle

From the masses described in the above-mentioned <Method for Separating Crystalline Vinyl Resin and Amorphous Resin from Toner Particle>, the content ratio of each component in the toner particle is calculated as follows.

[Content ratio of crystalline vinyl resin based on the mass of binder resin:

$$( unit : \% by mass ) ] = ( W 11 / ( W 11 + W 12 ) ) \times 100$$

### Method for Identifying Monomer Units Constituting Crystalline Vinyl Resin and Amorphous Resin, and Measuring Content Ratio of Monomer Units

The identification of the monomer units constituting the crystalline vinyl resin and the amorphous resin and the measurement of the content ratios of monomer units are performed by 1H-NMR under the following conditions.
Measurement device: FT NMR device JNM-EX400 (manufactured by JEOL Ltd.)
Measurement frequency: 400 MHZ
Pulse condition: 5.0 μs
Frequency range: 10500 Hz
Number of times of accumulation: 64
Measurement temperature: 30° C.
Sample: 50 mg of the measurement sample is placed in a sample tube with an inner diameter of 5 mm, deuterated chloroform (CDCl₃) is added as a solvent, and this is dissolved in a thermostatic bath at 40° C. to prepare the sample.

The measurement sample can be any resin, such as crystalline vinyl resin, fractionated by the method described above.

The following is an explanation based on an example in which a crystalline vinyl resin is used. From among the peaks attributed to the components of the monomer unit represented by formula (1), which is contained in the crystalline vinyl resin, in the obtained 1H-NMR chart, a peak that is independent of the peaks that are attributed to the components of other monomer unit is selected, and the integral value S₁ of this peak is calculated.

Similarly, the integral value S₂ is calculated for each of the other monomer unit contained in the crystalline vinyl resin.

For example, when the monomer units constituting the crystalline vinyl resin are the monomer unit represented by formula (1) and one other monomer unit, the content ratio of the monomer unit represented by formula (1) is obtained in the following manner by using the integral values S₁ and S₂. Here, n₁ and n₂ are the numbers of hydrogen atoms in the components to which the peaks of interest are attributed in respective segments.

$$Content ratio ( mol \% ) of the monomer unit represented by formula ( 1 ) = \{ ( {S}_{1} / {n}_{1} ) / ( ( {S}_{1} / {n}_{1} ) + ( {S}_{2} / {n}_{2} ) ) \} \times 100$$

$$Content ratio ( mol \% ) of other monomer unit = \{ ( {S}_{2} / {n}_{2} ) / ( ( {S}_{1} / {n}_{1} ) + ( {S}_{2} / {n}_{2} ) ) \} \times 100$$

Even when there are two or more other monomer units, the content ratio of the monomer units can be calculated in the same manner (using S₃ . . . . Sₓ, n₃ . . . nₓ).

The content ratio of each monomer unit in the amorphous resin can be calculated in the same way.

When a polymerizable monomer that does not contain hydrogen atoms in the components other than the vinyl group is used, 13C-NMR is used with 13C as the measurement nucleus, the measurement is performed in a single pulse mode, and the calculation is performed in the same way as in the case of 1H-NMR.

The mole percent can be converted to percent by mass based on the molecular weight of the monomer unit.

The number of carbon atoms in the alkyl groups such as R⁵ in formula (1) can be calculated from the integral ratio of the proton peak in the 1H-NMR chart.

### Method for Measuring the Weight-Average Molecular Weight (Mw) of Resins etc. by Gel Permeation Chromatography (GPC)

The weight-average molecular weight (Mw) of tetrahydrofuran (THF)-soluble matter such as resins is measured as follows by permeation chromatography (GPC).

Firstly, a sample is dissolved in tetrahydrofuran (THF) over 24 hours at room temperature. The obtained solution is then filtered through a solvent-resistant membrane filter “MYSYORI DISC” (by Tosoh Corporation) having a pore diameter of 0.2 μm, to yield a sample solution. The sample solution is adjusted so that the concentration of the component soluble in THF is about 0.8 mass %. This sample solution is then used for measurements under the following conditions.
Device: HLC8220 GPC (detector: RI) (by Tosoh Corporation)
Column: 7 columns Shodex KF-801, 802, 803, 804, 805, 806 and 807 (by Showa Denko KK)
Eluent: tetrahydrofuran (THF)
Flow rate: 1.0 mL/min
Oven temperature: 40.0° C.
Sample injection volume: 0.10 mL

To calculate the molecular weight of the sample there is used a molecular weight calibration curve created using a standard polystyrene resin (product name “TSK STANDARD POLYSTYRENE F-850, F-450, F-288, F-128, F-80, F-40, F-20, F-10, F-4, F-2, F-1, A-5000, A-2500, A-1000 or A-500”, by Tosoh Corporation).

### Method for Measuring Weight-average Particle Diameter (D4) of Toner (Toner Particle)

The weight-average particle diameter (D4) of the toner (toner particle) is calculated by carrying out measurements using a precision particle size distribution measuring device which employees a pore electrical resistance method and uses a 100 μm aperture tube (“Coulter Counter Multisizer 3” (registered trademark) available from Beckman Coulter) and accompanying dedicated software that is used to set measurement conditions and analyze measured data (“Beckman Coulter Multisizer 3 Version 3.51 produced by Beckman Coulter) (no. of effective measurement channels: 25,000), and then analyzing the measurement data.

A solution obtained by dissolving special grade sodium chloride in ion exchanged water at a concentration of approximately 1 mass %, such as “ISOTON II” (produced by Beckman Coulter), can be used as an aqueous electrolyte solution used in the measurements. Moreover, the dedicated software was set up as follows before carrying out measurements and analysis.

On the “Standard Operating Method (SOM) alteration screen” in the dedicated software, the total count number in control mode is set to 50,000 particles, the number of measurements is set to 1, and the Kd value is set to “standard particle 10.0 μm” (Beckman Coulter). By pressing the threshold value/noise level measurement button, threshold values and noise levels are automatically set. In addition, the current is set to 1600 μA, the gain is set to 2, the electrolyte solution is set to ISOTON II, and the “Flush aperture tube after measurement” option is checked. On the “Screen for converting from pulse to particle diameter” in the dedicated software, the bin interval is set to logarithmic particle diameter, the particle diameter bin is set to 256 particle diameter bin, and the particle diameter range is set to from 2 μm to 60 μm. The specific measurement method is as follows.
(1) 200 mL of the aqueous electrolyte solution is placed in a dedicated Multisizer 3 250 mL glass round bottomed beaker, the beaker is set on a sample stand, and a stirring rod is rotated anticlockwise at a rate of 24 rotations/second. By carrying out the “Aperture tube flush” function of the dedicated software, dirt and bubbles in the aperture tube are removed.
(2) 30 mL of the aqueous electrolyte solution is placed in a 100 mL glass flat bottomed beaker, and approximately 0.3 mL of a diluted liquid, which is obtained by diluting “Contaminon N” (a 10 mass % aqueous solution of a neutral detergent for cleaning precision measurement equipment, which has a pH of 7 and comprises a non-ionic surfactant, an anionic surfactant and an organic builder, available from Wako Pure Chemical Industries, Ltd.) 3-fold with ion exchanged water, is added to the beaker as a dispersing agent.
(3) A prescribed amount of ion exchanged water is placed in a water bath of an “Ultrasonic Dispersion System Tetora 150” (available from Nikkaki Bios Co., Ltd.) having an electrical output of 120 W, in which 2 oscillators having an oscillation frequency of 50 kHz are housed so that their phases are staggered by 180°, and approximately 2 mL of the Contaminon N is added to the water bath.
(4) The beaker used in step (2) above is placed in a beaker-fixing hole in the ultrasonic wave disperser, and the ultrasonic wave disperser is activated. The height of the beaker is adjusted so that the resonant state of the liquid surface of the aqueous electrolyte solution in the beaker is at a maximum.
(5) While the aqueous electrolyte solution in the beaker mentioned in section (4) above is being irradiated with ultrasonic waves, approximately 10 mg of toner particles are added a little at a time to the aqueous electrolyte solution and dispersed therein. The ultrasonic wave dispersion treatment is continued for a further 60 seconds. Moreover, when carrying out the ultrasonic wave dispersion, the temperature of the water bath is adjusted as appropriate to a temperature of from 10° C. to 40° C.
(6) The aqueous electrolyte solution mentioned in section (5) above, in which the toner (toner particle) is dispersed, is added dropwise by means of a pipette to the round bottomed beaker mentioned in section (1) above, which is disposed on the sample stand, and the measurement concentration is adjusted to approximately 5%. Measurements are carried out until the number of particles measured reaches 50,000.
(7) The weight average particle diameter (D4) is calculated by analyzing measurement data using the accompanying dedicated software. Moreover, when setting the graph/vol. % with the dedicated software, the “average diameter” on the analysis/volume-based statistical values (arithmetic mean) screen is weight average particle diameter (D4).

### Method for Measuring Average Circularity of Toner

The average circularity of the toner is measured by a flow type particle image analyzer “FPIA-3000” (manufactured by Sysmex Corporation) under the measurement and analysis conditions at the time of calibration.

The measurement principle of the flow type particle image analyzer “FPIA-3000” (manufactured by Sysmex Corporation) is to capture an image of flowing particles as a still image and perform image analysis. The sample added to a sample chamber is fed to a flat sheath flow cell by a sample suction syringe. The sample fed into the flat sheath flow is sandwiched by the sheath liquid to form a flat flow. The sample passing through the flat sheath flow cell is irradiated with strobe light at intervals of 1/60 sec, and the image of flowing particles can be captured as a still image. Further, since the flow is flat, the image is captured in focus. The particle image is captured by a CCD camera, and the captured image is subjected to image processing with an image processing resolution of 512× 512 pixels (0.37× 0.37 μm per pixel), the outline of each particle image is extracted, and a projected area S, a perimeter L and the like of the particle image are measured.

Next, a circle-equivalent diameter and a circularity are determined using the area S and the perimeter L. The circle-equivalent diameter is the diameter of a circle having the same area as the projected area of the particle image, and the circularity C is determined as a value obtained by dividing the perimeter of the circle determined from the circle-equivalent diameter by the perimeter of the particle projection image. The circularity is calculated by the following formula.

$$Circularity C = 2 \times {( π \times S )}^{1 / 2} / L$$

When the particle image is circular, the circularity is 1.000, and the circularity assumes a smaller value as the degree of unevenness on the periphery of the particle image increases. After calculating the circularity of each particle, the range of circularity of from 0.200 to 1.000 is divided into 800, the arithmetic mean value of the circularities obtained is calculated, and this value is defined as the average circularity.

The specific measurement method is described hereinbelow.

First, about 20 mL of ion exchanged water from which solid impurities and the like have been removed in advance is placed in a glass container. About 0.2 mL of a diluent prepared by diluting “CONTAMINON N” (10% by mass aqueous solution of a neutral detergent for washing precision measuring instruments of pH 7 consisting of a nonionic surfactant, an anionic surfactant, and an organic builder, manufactured by Wako Pure Chemical Industries, Ltd.) with about three-fold mass of ion exchanged water is added as a dispersing agent thereto.

Further, about 0.02 g of a measurement sample is added, and dispersion treatment is performed for 2 min using an ultrasonic wave disperser to obtain a dispersion for measurement. At that time, the dispersion solution is suitably cooled to a temperature of 10° C. to 40° C. As the ultrasonic wave disperser, a table-top type ultrasonic cleaner disperser (“VS-150” (manufactured by VELVO-CLEAR Co.)) having an oscillation frequency of 50 kHz and an electric output of 150 W is used, a predetermined amount of ion exchanged water is placed into a water tank, and about 2 mL of the CONTAMINON N is added to the water tank.

For measurement, the flow type particle image analyzer equipped with a standard objective lens (×10) is used, and a particle sheath “PSE-900A” (manufactured by Sysmex Corporation) is used as a sheath liquid. The dispersion solution prepared according to the procedure is introduced into the flow type particle image analyzer, and 3,000 toner particles are measured in a total count mode in an HPF measurement mode.

Then, the binarization threshold value at the time of particle analysis is set to 85%, the particle diameter to be analyzed is set to a circle-equivalent diameter of 1.98 μm to 39.96 μm, and the average circularity of the toner is obtained.

In the measurement, automatic focusing is performed using standard latex particles (for example, “RESEARCH AND TEST PARTICLES Latex Microsphere Suspensions 5200A” manufactured by Duke Scientific Inc. which are diluted with ion exchanged water) before the start of the measurement. After that, it is preferable to perform focusing every 2 h from the start of the measurement.

Method for Measuring 50% Particle Size (D50), Based on Volume Distribution, of Polymer Fine Particles, Amorphous Resin Fine Particles Other than Polymer A, Aliphatic Hydrocarbon Compound Fine Particles, and Colorant Fine Particles

A dynamic light scattering type particle size distribution meter NANOTRAC UPA-EX150 (manufactured by Nikkiso Co., Ltd.) is used for measuring the 50% particle size (D50), based on volume distribution, of polymer fine particles, amorphous resin fine particles other than the polymer A, aliphatic hydrocarbon compound fine particles, and colorant fine particles. Specifically, the measurement is performed according to the following procedure.

In order to prevent aggregation of the measurement sample, the dispersion solution in which the measurement sample is dispersed is introduced into an aqueous solution including FAMILY FRESH (manufactured by Kao Corporation) and stirred.

After stirring, the measurement sample is injected into the abovementioned device, the measurement is performed twice, and the average value is determined.

As the measurement conditions, the measurement time is 30 sec, the sample particle refractive index is 1.49, the dispersion medium is water, and the dispersion medium refractive index is 1.33.

The volume particle size distribution of the measurement sample is measured, and the particle diameter at which the cumulative volume from the small particle diameter side in the cumulative volume distribution from the measurement results is 50% is taken as the 50% particle diameter (D50), based on the volume distribution, of each particle.

### Method for Measuring Melting Point of Crystalline Vinyl Resin; Peak Top Tm

The melting point of crystalline vinyl resin is measured using a DSC Q1000 (manufactured by TA Instruments) under the following conditions.
Heating rate: 10° C./min
Measurement start temperature: 20° C.
Measurement end temperature: 180° C.

The melting points of indium and zinc are used to correct the temperature of the detection unit of the device, and the heat of fusion of indium is used to correct the amount of heat.

Specifically, 5 mg of the sample is precisely weighed and placed in an aluminum pan, and differential scanning calorimetry is performed. An empty silver pan is used as a reference.

The peak temperature of the maximum endothermic peak in the first temperature rise process is taken as the melting point of the crystalline vinyl resin and considered as peak top Tm.

When there are multiple peaks, the maximum endothermic peak is the peak with the largest amount of endothermic heat.

### EXAMPLES

The present disclosure will now be explained in greater detail using the working examples given below. However, these working examples in no way limit the present disclosure. In the formulations below, “parts” always means parts by mass unless explicitly indicated otherwise.

### Production Example of Monomer 1 Capable of Forming Monomer Unit Represented by Formula (1)

The following materials were placed in a reaction vessel equipped with a reflux condenser, a stirrer, a thermometer, and a nitrogen introduction tube under a nitrogen atmosphere.

| | | |
|---|---|---|
| Behenyl alcohol | 883 | parts |
| (66 mol % relative to the total number | | |
| of moles of alcohol and carboxylic acid) | | |
| Fumaric acid | 164 | parts |
| (34 mol % relative to the total number | | |
| of moles of alcohol and carboxylic acid) | | |
| Dibutyltin oxide | 2.5 | parts |
| 2,6-Di-tert-butyl-p-cresol | 1.0 | parts |

Next, the atmosphere in a flask was replaced with nitrogen gas, the temperature was gradually raised while stirring, and the mixture was homogenized at 120° C. by stirring. The temperature was then raised to 165° C., and the mixture was esterified under reduced pressure at 21 kPa for 3 h, while removing the distillate, and then esterified under reduced pressure at 21 kPa for 3 h by removing the distillate to obtain monomer 1.

### Production Examples of Monomers 2 to 10 Capable of Forming Monomer Unit Represented by Formula (1)

Monomers 2 to 10 were obtained by carrying out the reaction in the same manner as in the production example of monomer 1, except that the raw material mixture was changed as shown in Table 2.

TABLE 1

| Monomer | First alcohol | | | Second alcohol | | | Carboxylic acid | |
|---|---|---|---|---|---|---|---|---|
| No. | Alcohol | C | mol % | Alcohol | C | mol % | Carboxylic acid | mol % |
| 1 | Behenyl alcohol | 22 | 66 | | | | Fumaric acid | 34 |
| 2 | Behenyl alcohol | 22 | 33 | Stearyl | 18 | 33 | Fumaric acid | 34 |
| | | | | alcohol | | | | |
| 3 | Cetanol | 16 | 66 | | | | Fumaric acid | 34 |
| 4 | 1-Tetracosanol | 24 | 66 | | | | Fumaric acid | 34 |
| 5 | Behenyl alcohol | 22 | 66 | | | | Methylenemalonic | 34 |
| | | | | | | | acid | |
| 6 | Behenyl alcohol | 22 | 66 | | | | Itaconic acid | 34 |
| 7 | 1-Triacontanol | 30 | 66 | | | | Fumaric acid | 34 |
| 8 | Behenyl alcohol | 22 | 50 | | | | Acrylic acid | 50 |
| 9 | 1-Tetradecanol | 14 | 66 | | | | Fumaric acid | 34 |
| 10 | 1-Dotriacontanol | 32 | 66 | | | | Fumaric acid | 34 |

In the table, C indicates the number of carbon atoms when each monomer corresponds to R⁵ in formula (1).

### Production Example of Crystalline Vinyl Resin 1

| | |
|---|---|
| Solvent: toluene | 100.0 parts |
| Monomer composition | 100.0 parts |
| (The monomer composition is obtained by mixing monomer | |
| 1, acrylonitrile, and styrene in the ratios shown below) | |
| [Monomer 1: 60.0 parts] | |
| [Acrylonitrile: 16.0 parts] | |
| [Styrene: 24.0 parts] | |
| Polymerization initiator: 0.5 parts | |
| [t-Butyl peroxypivalate (Perbutyl PV, | |
| manufactured by NOF Corp.)] | |

The above materials were placed in a reaction vessel equipped with a reflux condenser, a stirrer, a thermometer, and a nitrogen introduction tube under a nitrogen atmosphere. The reaction vessel was heated to 70° C. while stirring at 200 rpm to carry out a polymerization reaction for 12 h, and a solution in which the polymer of the monomer composition was dissolved in toluene was obtained.

Next, the temperature of the solution was lowered to 25° C., and the solution was then poured into 1000.0 parts of methanol while stirring to precipitate the methanol insoluble matter. The resulting methanol insoluble matter was filtered off, washed with methanol, and vacuum dried at 40° C. for 24 h to obtain crystalline vinyl resin 1. The physical properties are shown in Table 2.

### Production Example of Crystalline Vinyl Resins 2 to 21

The reaction was carried out in the same manner as in the production example of crystalline vinyl resin 1, except that the monomers and parts by mass were changed as shown in Table 2, to obtain crystalline vinyl resins 2 to 21. The physical properties are shown in Table 3.

When using fumaric acid selected as the carboxylic acid as a monomer shown in Table 1, a crystalline vinyl resin containing a monomer unit in which either R¹ or R² and either R³ or R⁴ in formula (1) are —COOR⁵ is obtained. When methylenemalonic acid is selected as the monomer, a vinyl resin containing a monomer unit in which R¹ and R² (or R³ and R⁴) are —COOR⁵ is obtained. When itaconic acid is selected as the monomer, a vinyl resin containing a monomer unit in which either R¹ or R² (or either R³ or R⁴) is —X—COOR⁵ (X is a methylene group with one carbon atom) and the other is —COOR⁵ is obtained. When acrylic acid is selected, a crystalline vinyl resin containing a monomer unit in which at least one of R¹, R², R³, and R⁴ is —COOR⁵ is obtained.

TABLE 2

| | Monomers capable | | | | | | | |
|---|---|---|---|---|---|---|---|---|
| | of forming monomer | | Second | | Third | | Fourth | |
| Crystalline | unit of formula (1) | | polymerizable | | polymerizable | | polymerizable | |
| vinyl resin | Monomer | | monomer | | monomer | | monomer | |
| No. | No. | Parts | Type | Parts | Type | Parts | Type | Parts |
| 1 | 1 | 60.0 | Acrylonitrile | 16.0 | Styrene | 24.0 | | |
| 2 | 2 | 58.0 | Acrylonitrile | 17.0 | Styrene | 25.0 | | |
| 3 | 1 | 67.0 | Acrylonitrile | 33.0 | Styrene | 0.0 | | |
| 4 | 2 | 54.0 | Acrylonitrile | 6.0 | Styrene | 40.0 | | |
| 5 | 1 | 53.0 | Acrylonitrile | 4.0 | Styrene | 43.0 | | |
| 6 | 1 | 51.0 | Styrene | 49.0 | | | | |
| 7 | 1 | 57.0 | Acrylonitrile | 43.0 | | | | |
| 8 | 1 | 48.0 | 2-Hydroxypropyl | 32.0 | Styrene | 20.0 | | |
| | | | acrylate | | | | | |
| 9 | 1 | 54.0 | Methyl acrylate | 24.0 | Styrene | 22.0 | | |
| 10 | 3 | 53.0 | Acrylonitrile | 19.0 | Styrene | 28.0 | | |
| 11 | 4 | 61.0 | Acrylonitrile | 16.0 | Styrene | 23.0 | | |
| 12 | 1 | 32.0 | 2-Hydroxypropyl | 31.0 | Styrene | 37.0 | | |
| | | | acrylate | | | | | |
| 13 | 1 | 28.0 | Acrylonitrile | 11.0 | 2-Hydroxypropyl | 16.0 | Styrene | 45.0 |
| | | | | | acrylate | | | |
| 14 | 5 | 60.0 | Acrylonitrile | 16.0 | Styrene | 24.0 | | |
| 15 | 6 | 60.0 | Acrylonitrile | 16.0 | Styrene | 24.0 | | |
| 16 | 7 | 65.0 | Acrylonitrile | 14.0 | Styrene | 21.0 | | |
| 17 | 1 | 6.0 | Acrylonitrile | 21.0 | Styrene | 73.0 | | |
| 18 | 8 | 60.0 | Acrylonitrile | 20.0 | Styrene | 20.0 | | |
| 19 | 9 | 51.0 | Acrylonitrile | 20.0 | Styrene | 29.0 | | |
| 20 | 10 | 67.0 | Acrylonitrile | 13.0 | Styrene | 20.0 | | |
| 21 | 1 | 4.0 | Acrylonitrile | 21.0 | Styrene | 75.0 | | |

TABLE 3

| Crystalline | | Endothermic peak |
|---|---|---|
| vinyl resin | | top temperature |
| No. | Mw | Tm [° C.] |
| 1 | 27000 | 60 |
| 2 | 22400 | 52 |
| 3 | 20100 | 60 |
| 4 | 25400 | 60 |
| 5 | 20400 | 60 |
| 6 | 19900 | 60 |
| 7 | 20100 | 60 |
| 8 | 23100 | 60 |
| 9 | 27200 | 60 |
| 10 | 23700 | 45 |
| 11 | 21800 | 65 |
| 12 | 20900 | 52 |
| 13 | 24600 | 50 |
| 14 | 25700 | 60 |
| 15 | 22200 | 60 |
| 16 | 24300 | 80 |
| 17 | 21600 | 50 |
| 18 | 21000 | 59 |
| 19 | 23100 | 40 |
| 20 | 29300 | 84 |
| 21 | 20500 | 50 |

### Production Example of Amorphous Resin 1

The following materials were placed in a reaction vessel equipped with a reflux condenser, a stirrer, a thermometer, and a nitrogen introduction tube under a nitrogen atmosphere.
Terephthalic acid: 633 parts
Behenic acid: 31 parts
1,2-Propanediol: 173 parts
(24.8 mol % relative to the total number of moles of polycarboxylic acids)
   Neopentyl glycol: 251 parts
(26.3 mol % relative to the total number of moles of polycarboxylic acids)
   Titanium diisopropoxy bistriethanol aminate: 2.0 parts

The atmosphere in the flask was replaced with nitrogen gas, and the mixture was homogenized by stirring for 30 min. The temperature was then gradually raised, esterification was carried out under reduced pressure at 0.45 MPa and 227° C. for 5 h, followed by esterification under reduced pressure at 4 kPa or less, 161 parts of 1.2-propanediol was recovered, and after cooling to 180° C., 2 parts of 2.6-di-tert-butyl-4-methylphenol was added, followed by homogenization for 30 min. Then, 68 parts of fumaric acid was added, esterification under reduced pressure was carried out at 180° C. for 2 h, followed by esterification under reduced pressure at 4 kPa or less for 15 h, and the mixture was removed from the reaction vessel to obtain a polyester resin (amorphous resin 1).

### Production Example of Amorphous Resin 2

A total of 50.0 parts of xylene was charged into an autoclave, and after replacing he atmosphere in the autoclave with nitrogen, the temperature was raised to 185° C. in a sealed state while stirring.

A mixed solution of 37.0 parts of styrene, 20.0 parts of n-butyl acrylate, 3.0 parts of methyl methacrylate, 18.0 parts of methyl acrylate, 25.0 parts of acrylonitrile, and also 1.0 part of di-tert-butyl peroxide and 40.0 parts of xylene was continuously added dropwise to the autoclave for 3 h while controlling the temperature inside the autoclave at 190° C., and polymerization was carried out. The same temperature was maintained for another hour to complete the polymerization, and the solvent was removed to obtain amorphous resin 2.

Production Example of Dispersion Liquid of Crystalline Vinyl Resin Fine Particles 1
Toluene (manufactured by Wako Pure Chemical Industries, Ltd.): 300 parts
Crystalline vinyl resin 1:100 parts

The above materials were weighed, mixed, and dissolved at 90° C.

Separately, 5.0 parts of sodium dodecylbenzenesulfonate and 10.0 parts of sodium laurate were added to 700 parts of ion-exchanged water and dissolved by heating at 90° C.

The toluene solution and the aqueous solution were then mixed and stirred at 7000 rpm using an ultra-high-speed stirring device T. K. Robomix (manufactured by Primix Corporation). Furthermore, the mixture was emulsified at a pressure of 200 MPa using a high-pressure impact disperser Nanomizer (manufactured by Yoshida Kikai Co., Ltd.). After that, the toluene was removed using an evaporator, and the concentration was adjusted with ion-exchanged water to obtain an aqueous dispersion liquid (dispersion liquid of crystalline vinyl resin fine particles 1) with a concentration of crystalline vinyl resin fine particles 1 of 20% by mass.

The 50% particle diameter (D50) of crystalline vinyl resin fine particles 1 based on volume distribution was measured using a dynamic light scattering particle diameter distribution meter Nanotrac UPA-EX150 (manufactured by Nikkiso Co., Ltd.) and found to be 0.40 μm.

### Production Example of Dispersion Liquids of Crystalline Vinyl Resin Fine Particles 2 to 21

Dispersion liquids of crystalline vinyl resin fine particles 2 to 21 were obtained by performing the emulsification in the same manner as in the production example of the dispersion liquid of crystalline vinyl resin fine particles 1, except that the crystalline vinyl resins were changed as shown in Table 4. The physical properties of dispersion liquids of crystalline vinyl resin fine particles 2 to 21 are shown in Table 4.

TABLE 4

| | | | | Aqueous solution | | |
|---|---|---|---|---|---|---|
| Dispersion liquid | Toluene solution | | | Sodium | | Physical |
| of crystalline | | Crystalline | | dodecylbenzene | Sodium | properties |
| vinyl resin fine | Toluene | vinyl resin | | sulfonate | laurate | D50 |
| particles No. | Parts | No. | Parts | Parts | Parts | [μm] |
| 1 | 300 | 1 | 100 | 5 | 10 | 0.4 |
| 2 | 300 | 2 | 100 | 5 | 10 | 0.4 |
| 3 | 300 | 3 | 100 | 5 | 10 | 0.4 |
| 4 | 300 | 4 | 100 | 5 | 10 | 0.4 |
| 5 | 300 | 5 | 100 | 5 | 10 | 0.4 |
| 6 | 300 | 6 | 100 | 5 | 10 | 0.4 |
| 7 | 300 | 7 | 100 | 5 | 10 | 0.4 |
| 8 | 300 | 8 | 100 | 5 | 10 | 0.4 |
| 9 | 300 | 9 | 100 | 5 | 10 | 0.4 |
| 10 | 300 | 10 | 100 | 5 | 10 | 0.4 |
| 11 | 300 | 11 | 100 | 5 | 10 | 0.4 |
| 12 | 300 | 12 | 100 | 5 | 10 | 0.4 |
| 13 | 300 | 13 | 100 | 5 | 10 | 0.4 |
| 14 | 300 | 14 | 100 | 5 | 10 | 0.4 |
| 15 | 300 | 15 | 100 | 5 | 10 | 0.4 |
| 16 | 300 | 16 | 100 | 5 | 10 | 0.4 |
| 17 | 300 | 17 | 100 | 5 | 10 | 0.4 |
| 18 | 300 | 18 | 100 | 5 | 10 | 0.4 |
| 19 | 300 | 19 | 100 | 5 | 10 | 0.4 |
| 20 | 300 | 20 | 100 | 5 | 10 | 0.4 |
| 21 | 300 | 21 | 100 | 5 | 10 | 0.4 |

### Production Example of Dispersion Liquid of Amorphous Resin Fine Particles 1

Tetrahydrofuran (manufactured by Wako Pure Chemical Industries, Ltd.): 300 parts
Amorphous resin 1:100 parts
Anionic surfactant Neogen RK (DKS Co., Ltd.): 0.5 parts

The above materials were weighed, mixed, and dissolved.

Next, 20.0 parts of 1 mol/L ammonia water was added, and the mixture was stirred at 4000 rpm using an ultra-high-speed stirring device T. K. Robomix (manufactured by Primix Corporation). Furthermore, 700 parts of ion-exchanged water was added at a rate of 8 g/min to precipitate amorphous resin fine particles. After that, tetrahydrofuran was removed using an evaporator, and the concentration was adjusted with ion-exchanged water to obtain an aqueous dispersion (dispersion liquid of amorphous resin fine particles 1) with a concentration of amorphous resin fine particles 1 of 20% by mass.

The 50% particle diameter (D50) of the amorphous resin fine particles 1 based on volume distribution was 0.13 μm.

### Production Example of Dispersion Liquid of Amorphous Resin Fine Particles 2

Tetrahydrofuran (manufactured by Wako Pure Chemical Industries, Ltd.): 300 parts
Amorphous resin 2: 100 parts

The above materials were weighed, mixed, and dissolved.

Separately, 5.0 parts of sodium dodecylbenzenesulfonate was added to 700 parts of ion-exchanged water and dissolved.

The toluene solution and the aqueous solution were then mixed and stirred at 7000 rpm using an ultra-high-speed stirring device T. K. Robomix (manufactured by Primix Corporation). The mixture was then emulsified at a pressure of 200 MPa using a high-pressure impact disperser Nanomizer (manufactured by Yoshida Kikai Co., Ltd.). After that, tetrahydrofuran was removed using an evaporator, and the concentration was adjusted with ion-exchanged water to obtain an aqueous dispersion liquid (dispersion liquid of amorphous resin fine particles 2) with a concentration of amorphous resin fine particles 2 of 20% by mass.

The 50% particle diameter (D50) based on volume distribution of amorphous resin particle 2 was 0.13 μm.

### Production Example of Release Agent (Aliphatic Hydrocarbon Compound) Particle Dispersion Liquid

Aliphatic hydrocarbon compound HNP-51 (manufactured by Nippon Seiro Co., Ltd.): 100 parts
Anionic surfactant Neogen RK (manufactured by DKS Co., Ltd.): 5 parts
Ion-exchanged water: 395 parts

The above materials were weighed and placed in a mixing vessel equipped with a stirrer, then heated to 90° C. and circulated through Clearmix W Motion (manufactured by M Technique Co., Ltd.) for 60 min for dispersion processing. The dispersion processing conditions were as follows.
Rotor outer diameter: 3 cm
Clearance: 0.3 mm
Rotor rotation speed: 19000 r/min
Screen rotation speed: 19000 r/min

After dispersion processing, the dispersion liquid was cooled to 40° C. at a rotor rotation speed of 1000 r/min, a screen rotation speed of 0 r/min, and a cooling rate of 10° C./min as cooling conditions to obtain an aqueous dispersion (release agent (aliphatic hydrocarbon compound) fine particle dispersion liquid) with a release agent (aliphatic hydrocarbon compound) fine particle concentration of 20% by mass.

The 50% particle diameter (D50) of the release agent (aliphatic hydrocarbon compound) fine particles based on the volume distribution was measured using a dynamic light scattering particle diameter distribution meter Nanotrac UPA-EX150 (manufactured by Nikkiso Co., Ltd.) and found to be 0.15 μm.

### Production of Colorant Fine Particle Dispersion Liquid

Colorant: 50.0 parts
   (Cyan pigment, manufactured by Dainichiseika Color & Chemicals Mfg. Co., Ltd.: Pigment Blue 15:3)
Anionic surfactant Neogen RK (manufactured by DKS Co., Ltd.): 7.5 parts
Ion-exchanged water: 442.5 parts

The above materials were weighed, mixed, dissolved, and dispersed for 1 hour using a high-pressure impact disperser Nanomizer (manufactured by Yoshida Kikai Co., Ltd.) to obtain an aqueous dispersion (colorant fine particle dispersion liquid) with a concentration of 10% by mass of colorant fine particles in which the colorant was dispersed.

The 50% particle diameter (D50) of the colorant fine particles based on the volume distribution was measured using a dynamic light scattering particle diameter distribution analyzer Nanotrac UPA-EX150 (manufactured by Nikkiso Co., Ltd.) and found to be 0.20 μm.

### Production Example of Toner 1

| | | |
|---|---|---|
| Dispersion liquid of crystalline | 300 | parts |
| vinyl resin fine particles 1 | | |
| Dispersion liquid of amorphous resin fine particles 1 | 200 | parts |
| Release agent (aliphatic hydrocarbon | 50 | parts |
| compound) fine particle dispersion liquid | | |
| Colorant fine particle dispersion liquid | 80 | parts |
| Ion-exchanged water | 160 | parts |

The above materials were placed in a round stainless steel flask and mixed, after which 40 parts of a 5% magnesium sulfate aqueous solution was added. Next, the mixture was dispersed at 5000 r/min for 10 min using a homogenizer Ultra Turrax T50 (manufactured by IKA Works, Inc.). After that, the mixture was heated to 58° C. in a heated water bath while using a stirring blade and appropriately adjusting the rotation speed so that the mixture was stirred.

The volume-average particle diameter of the formed aggregated particles was confirmed, as appropriate, using a Coulter Multisizer III. When aggregated particles with a volume-average particle diameter of approximately 6.00 μm were formed, 300 parts of a 5% aqueous solution of sodium ethylenediaminetetraacetate was added, and the mixture was heated to 75° C. while continuing to stir. The aggregated particles were then fused by holding at 75° C. for 1 h.

The mixture was then cooled to 50° C. and held for 3 hours to promote crystallization of the polymer.

Then, the mixture was cooled to 25° C., filtered and solid-liquid separated, and washed with ion-exchanged water. The washing was followed by drying using a vacuum dryer to obtain toner particles 1 with a weight-average particle diameter (D4) of approximately 6.07 μm.

| | | |
|---|---|---|
| Toner particles 1 | 100 | parts |
| Large-diameter silica fine particles with an | 3 | parts |
| average particle diameter of 130 nm, surface- | | |
| treated with hexamethyldisilazane | | |
| Small-diameter silica fine particles with an | 1 | part |
| average particle diameter of 20 nm, surface- | | |
| treated with hexamethyldisilazane | | |

The above materials were mixed in a Henschel mixer FM-10C (manufactured by Mitsui Miike Machinery Co., Ltd.) at a rotation speed of 30 s⁻¹ and a rotation time of 10 min to obtain toner 1. The constituent materials of toner 1 are shown in Table 5.

The weight-average particle diameter (D4) of toner 1 was 6.1 μm, and the average circularity was 0.975. The physical properties of toner 1 are shown in Table 6.

TABLE 5

| | Formulation | | | | | | | |
|---|---|---|---|---|---|---|---|---|
| | Dispersion liquid | | Dispersion liquid | | | | | |
| | of crystalline vinyl | | of amorphous resin | | | | | |
| Toner | resin fine particles | | fine particles | | Flocculant | | Stopper | |
| No. | No. | Parts | No. | Parts | Type | Parts | Type | Parts |
| 1 | 1 | 300 | 1 | 200 | Mg | 40 | Na | 300 |
| 2 | 2 | 300 | 1 | 200 | Mg | 40 | Na | 300 |
| 3 | 1 | 300 | 2 | 200 | Mg | 40 | Na | 300 |
| 4 | 2 | 300 | 2 | 200 | Mg | 40 | Na | 300 |
| 5 | 3 | 300 | 1 | 200 | Al | 15 | Na | 480 |
| 6 | 4 | 300 | 1 | 200 | Mg | 40 | Na | 300 |
| 7 | 5 | 300 | 1 | 200 | Mg | 40 | Na | 300 |
| 8 | 6 | 300 | 1 | 200 | Mg | 40 | Na | 300 |
| 9 | 7 | 300 | 1 | 200 | Mg | 40 | Na | 300 |
| 10 | 8 | 300 | 1 | 200 | Mg | 40 | Na | 300 |
| 11 | 9 | 300 | 1 | 200 | Mg | 40 | Na | 300 |
| 12 | 10 | 300 | 1 | 200 | Mg | 40 | Na | 300 |
| 13 | 11 | 300 | 1 | 200 | Mg | 40 | Na | 300 |
| 14 | 1 | 250 | 1 | 250 | Mg | 40 | Na | 300 |
| 15 | 1 | 400 | 1 | 100 | Mg | 40 | Na | 300 |
| 16 | 1 | 200 | 1 | 300 | Mg | 40 | Na | 300 |
| 17 | 1 | 450 | 1 | 50 | Mg | 40 | Na | 300 |
| 18 | 12 | 300 | 1 | 200 | Mg | 40 | Na | 300 |
| 19 | 13 | 300 | 1 | 200 | Mg | 40 | Na | 300 |
| 20 | 14 | 300 | 1 | 200 | Mg | 40 | Na | 300 |
| 21 | 15 | 300 | 1 | 200 | Mg | 40 | Na | 300 |
| 22 | 1 | 175 | 1 | 325 | Mg | 40 | Na | 300 |
| 23 | 1 | 125 | 1 | 375 | Mg | 40 | Na | 300 |
| 24 | 16 | 300 | 1 | 200 | Mg | 40 | Na | 300 |
| 25 | 1 | 300 | 1 | 200 | Mg | 40 | QNa | 300 |
| 26 | 1 | 300 | 1 | 200 | Ca | 40 | Na | 300 |
| 27 | 1 | 300 | 1 | 200 | Zn | 40 | Na | 300 |
| 28 | 1 | 300 | 1 | 200 | Al | 24 | Na | 300 |
| 29 | 17 | 300 | 1 | 200 | Mg | 40 | Na | 300 |
| 30 | 18 | 300 | 1 | 200 | Mg | 40 | Na | 300 |
| 31 | 19 | 300 | 1 | 200 | Mg | 40 | Na | 300 |
| 32 | 20 | 300 | 1 | 200 | Mg | 40 | Na | 300 |
| 33 | 1 | 300 | 1 | 200 | Al | 20 | Na | 300 |
| 34 | 1 | 300 | 1 | 200 | Mg | 40 | QNa | 300 |
| 35 | 21 | 300 | 1 | 200 | Mg | 40 | Na | 300 |
| 36 | — | 0 | 1 | 500 | Mg | 40 | Na | 300 |

| | |
|---|---|
| 37 | Mentioned in the specification |

The abbreviations in Table 5 are as follows:
Mg: 5% magnesium sulfate aqueous solution
Al: 5% aluminum chloride aqueous solution
Ca: 5% calcium chloride aqueous solution
Zn: 5% zinc chloride aqueous solution
Na: 5% sodium ethylenediaminetetraacetate aqueous solution
QNa: 5% trisodium citrate aqueous solution

TABLE 6

| | Physical properties | | | | |
|---|---|---|---|---|---|
| | | | Weight- | | |
| | Content of | | average | | |
| | polyvalent | | particle | Polyvalent | |
| Toner | metal | CV | diameter | metal/ | Average |
| No. | [ppm] | mass % | D4[μm] | Formula (1) | circularity |
| 1 | 300 | 60 | 6.1 | 9.9 | 0.975 |
| 2 | 300 | 60 | 6.1 | 10.3 | 0.975 |
| 3 | 300 | 60 | 6.1 | 9.9 | 0.975 |
| 4 | 300 | 60 | 6.1 | 10.3 | 0.975 |
| 5 | 30 | 60 | 6.1 | 0.9 | 0.975 |
| 6 | 300 | 60 | 6.1 | 11.0 | 0.975 |
| 7 | 300 | 60 | 6.1 | 11.2 | 0.975 |
| 8 | 300 | 60 | 6.1 | 11.7 | 0.975 |
| 9 | 300 | 60 | 6.1 | 10.4 | 0.975 |
| 10 | 300 | 60 | 6.1 | 12.4 | 0.975 |
| 11 | 300 | 60 | 6.1 | 11.0 | 0.975 |
| 12 | 300 | 60 | 6.1 | 11.2 | 0.975 |
| 13 | 300 | 60 | 6.1 | 9.8 | 0.975 |
| 14 | 300 | 50 | 6.1 | 11.9 | 0.975 |
| 15 | 300 | 80 | 6.1 | 7.4 | 0.975 |
| 16 | 300 | 40 | 6.1 | 14.9 | 0.975 |
| 17 | 300 | 90 | 6.1 | 6.6 | 0.975 |
| 18 | 300 | 60 | 6.1 | 18.6 | 0.975 |
| 19 | 300 | 60 | 6.1 | 21.3 | 0.975 |
| 20 | 300 | 60 | 6.1 | 9.9 | 0.975 |
| 21 | 300 | 60 | 6.1 | 9.9 | 0.975 |
| 22 | 300 | 35 | 6.1 | 17.0 | 0.975 |
| 23 | 300 | 25 | 6.1 | 23.8 | 0.975 |
| 24 | 300 | 60 | 6.1 | 9.2 | 0.975 |
| 25 | 500 | 60 | 6.1 | 16.5 | 0.975 |
| 26 | 300 | 60 | 6.1 | 9.9 | 0.975 |
| 27 | 300 | 60 | 6.1 | 9.9 | 0.975 |
| 28 | 150 | 60 | 6.1 | 5.0 | 0.975 |
| 29 | 300 | 60 | 6.1 | 99.2 | 0.975 |
| 30 | 300 | 60 | 6.1 | — | 0.975 |
| 31 | 300 | 60 | 6.1 | 11.7 | 0.975 |
| 32 | 300 | 60 | 6.1 | 8.9 | 0.975 |
| 33 | 20 | 60 | 6.1 | 0.7 | 0.975 |
| 34 | 520 | 60 | 6.1 | 17.2 | 0.975 |
| 35 | 300 | 60 | 6.1 | 148.8 | 0.975 |
| 36 | 300 | 0 | 6.1 | — | 0.975 |
| 37 | 0 | 60 | 6.1 | 0.0 | 0.960 |

In the table, CV indicates the content (% by mass) of crystalline vinyl resin based on the mass of the binder resin. Polyvalent metal/formula (1) indicates the value (ppm/% by mass) of (content ratio of polyvalent metal)/(content ratio of monomer unit represented by formula (1)) in formula (2).

### Production Examples of Toners 2 to 36

Toners 2 to 36 were obtained by performing the same operations as in the production example of toner 1, except that in the production example of toner 1, the type and amount of dispersion liquid of crystalline vinyl resin fine particles 1, the type and amount of amorphous resin fine particle dispersion, the type and amount of flocculant, and the type and amount of stopper were changed as shown in Table 5 above. The physical properties are shown in Table 6.

When the toner obtained was analyzed by the method described above, the content ratio of each monomer unit in the crystalline vinyl resin was consistent with the formulations shown in Table 2.

### Production Example of Toner 37

Crystalline vinyl resin 1: 60.0 parts
Amorphous resin 1: 40.0 parts
Aliphatic hydrocarbon compound HNP-51 (manufactured by Nippon Seiro Co., Ltd.): 10.0 parts
Colorant: 8.0 parts
   (Cyan pigment, manufactured by Dainichiseika Color & Chemicals Mfg. Co., Ltd.: Pigment Blue 15:3)
3,5-di-t-Butyl salicylic acid aluminum compound: 0.03 parts

The above materials were mixed using a Henschel mixer (FM-75, manufactured by Mitsui Mining Co., Ltd.) at a rotation speed of 20 s⁻¹ and a rotation time of 5 min, and then melt-kneaded in a twin-screw kneader (PCM-30, manufactured by Ikegai Co., Ltd.) set at a temperature of 130° C.

The resulting kneaded material was cooled and coarsely pulverized to 1 mm or less using a hammer mill to obtain a coarsely pulverized material.

The resulting coarsely pulverized material was finely pulverized using a mechanical pulverizer (T-250, manufactured by Turbo Kogyo Co., Ltd.).

Furthermore, classification was performed using Faculty F-300 (manufactured by Hosokawa Micron Corporation) to obtain toner particles 37 with a weight-average particle diameter (D4) of approximately 6.07 μm. The operating conditions were a classification rotor rotation speed of 130 s⁻¹ and a dispersion rotor rotation speed of 120 s⁻¹.
Toner particles 37: 100 parts
Large-diameter silica fine particles with an average particle diameter of 130 nm, surface-treated with hexamethyldisilazane: 3 parts
Small-diameter silica fine particles with an average particle diameter of 20 nm, surface-treated with hexamethyldisilazane: 1 part

The above materials were mixed in a Henschel mixer FM-10C (manufactured by manufactured by Mitsui Miike Machinery Co., Ltd.) at a rotation speed of 30 s⁻¹ and a rotation time of 10 min to obtain toner 37. The weight-average particle diameter (D4) of toner 37 was 6.1 μm and the average circularity was 0.960. The physical properties of toner 37 are shown in Table 6.

### Production Example of Magnetic Carrier 1

Magnetite 1 with a number-average particle diameter of 0.30 μm (magnetization strength of 65 Am²/kg in a magnetic field of 1000/4π×(kA/m))
Magnetite 2 with a number average particle diameter of 0.50 μm (magnetization strength of 65 Am²/kg in a magnetic field of 1000/4π×(kA/m))

A total of 4.0 parts of a silane compound (3-(2-aminoethylaminopropyl) trimethoxysilane) was added to 100 parts of each of the above materials, and high-speed mixing and stirring were conducted at 100° C. or higher in a container to process respective fine particles.
Phenol: 10% by mass
Formaldehyde solution: 6% by mass (40% by mass of formaldehyde, 10% by mass of methanol, 50% by mass of water)
Magnetite 1 treated with the above silane compound: 58% by mass
Magnetite 2 treated with the above silane compound: 26% by mass

A total of 100 parts of the above materials, 5 parts of 28% by mass aqueous ammonia solution, and 20 parts of water were placed in a flask, the temperature was raised to 85° C. in 30 min while stirring and mixing, and the mixture was held for 3 h to polymerize and cure the resulting phenolic resin.

The cured phenolic resin was then cooled to 30° C., and water was further added, after which the supernatant liquid was removed, and the precipitate was washed with water and then air-dried. This was then dried under reduced pressure (5 mmHg or less) at a temperature of 60° C. to obtain magnetic body-dispersed spherical magnetic carrier 1. The 50% particle diameter (D50) based on volume of magnetic carrier 1 was 34.2 μm.

### Production Example of Two-Component Developer 1

A total of 8.0 parts of toner 1 was added to 92.0 parts of magnetic carrier 1 and mixed using a V-type mixer (V-20, manufactured by Seishin Enterprise Co., Ltd.) to obtain two-component developer 1.

### Production Examples of Two-Component Developers 2 to 37

Two-component developers 2 to 37 were obtained by carrying out production in the same manner as in the production example of two-component developer 1, except that the toner was changed as shown in Table 7.

TABLE 7

| Two-component developer | Toner No. | Carier No. |
|---|---|---|
| Two-component developer 1 | 1 | 1 |
| Two-component developer 2 | 2 | 1 |
| Two-component developer 3 | 3 | 1 |
| Two-component developer 4 | 4 | 1 |
| Two-component developer 5 | 5 | 1 |
| Two-component developer 6 | 6 | 1 |
| Two-component developer 7 | 7 | 1 |
| Two-component developer 8 | 8 | 1 |
| Two-component developer 9 | 9 | 1 |
| Two-component developer 10 | 10 | 1 |
| Two-component developer 11 | 11 | 1 |
| Two-component developer 12 | 12 | 1 |
| Two-component developer 13 | 13 | 1 |
| Two-component developer 14 | 14 | 1 |
| Two-component developer 15 | 15 | 1 |
| Two-component developer 16 | 16 | 1 |
| Two-component developer 17 | 17 | 1 |
| Two-component developer 18 | 18 | 1 |
| Two-component developer 19 | 19 | 1 |
| Two-component developer 20 | 20 | 1 |
| Two-component developer 21 | 21 | 1 |
| Two-component developer 22 | 22 | 1 |
| Two-component developer 23 | 23 | 1 |
| Two-component developer 24 | 24 | 1 |
| Two-component developer 25 | 25 | 1 |
| Two-component developer 26 | 26 | 1 |
| Two-component developer 27 | 27 | 1 |
| Two-component developer 28 | 28 | 1 |
| Two-component developer 29 | 29 | 1 |
| Two-component developer 30 | 30 | 1 |
| Two-component developer 31 | 31 | 1 |
| Two-component developer 32 | 32 | 1 |
| Two-component developer 33 | 33 | 1 |
| Two-component developer 34 | 34 | 1 |
| Two-component developer 35 | 35 | 1 |
| Two-component developer 36 | 36 | 1 |
| Two-component developer 37 | 37 | 1 |

### Example 1

Evaluation was carried out using the two-component developer 1.

As an image forming device, a modified Canon digital commercial printer imageRUNNER ADVANCE C7770 was used, and two-component developer 1 was placed in a cyan developer unit. Modifications to the device included changes made to enable free setting of the fixing temperature, process speed, DC voltage VDC of the developer carrying member, charging voltage VD of the electrostatic latent image bearing member, and laser power. Image output evaluation was performed by outputting an FFh image (solid image) with the desired image ratio, adjusting VDC, VD, and laser power so that the toner laid-on level on the FFh image on the paper was as desired, and then performing the evaluation described below.

FFh is a value that expresses 256 gradations in hexadecimal, with 00h being the first gradation (white background) of the 256 gradations and FFh being the 256th gradation (solid area) of the 256 gradations.

The evaluation was performed based on the following evaluation method, and the results are shown in Table 8.
Low-Temperature Fixability
Paper: GFC-081 (81.0 g/m²)

### (Sold by Canon Marketing Japan Inc.)

Toner laid-on level on paper: 0.90 mg/cm²

### (Adjusted by DC Voltage VDC of Developer Carrying Member, Charging Voltage VD of Electrostatic Latent Image Bearing Member, and Laser Power)

Evaluation image: 2 cm×15 cm image placed in the center of the A4 paper
Test environment: low temperature and low humidity environment: temperature 15° C./humidity 10% RH (hereinafter “L/L”)
Fixing temperature: 120° C.
Process speed: 300 mm/see

The evaluation image was output and low-temperature fixability was evaluated. The image density reduction rate was used as an evaluation index for low-temperature fixability.

The image density reduction rate was measured using the following procedure. First, the image density in the center was measured using an X-Rite color reflection densitometer (500 series: manufactured by X-Rite, Inc.). Next, a load of 4.9 kPa (50 g/cm²) was applied to the area where the image density had been measured, the fixed image was rubbed (10 times back and forth) with Silbon paper, and the image density was measured again.

The reduction rate of image density caused by rubbing was then calculated using the following formula. The resulting reduction rate of image density was evaluated according to the following evaluation criteria.

$$Image density reduction rate = ( image density before rubbing - image density after rubbing ) \text{} / ( image density before rubbing ) \times 100$$

### Evaluation Criteria

A: Image density reduction rate less than 2.0%
B: Image density reduction rate is 2.0% or more and less than 4.0%
C: Image density reduction rate is 4.0% or more and less than 6.0%
D: Image density reduction rate is 6.0% or more and less than 10.0%
E: Image density reduction rate is 10.0% or more

### Evaluation of Abrasion Resistance

Paper: OK Topcoat Matte N (128.0 g/m²)
(Sold by Canon Marketing Japan Inc.)
Toner laid-on level on paper: 0.05 mg/cm² (2Fh image)
(Adjusted by DC voltage VDC of developer carrying member, charging voltage V_{D} of electrostatic latent image bearing member, and laser power)
Evaluation image: 3 m×15 cm image placed in the center of the A4 paper
Fixing test environment: normal temperature and humidity environment (temperature 23° C./humidity 50% RH (hereinafter N/N))
Fixing temperature: 100° C.
Process speed: 132 mm/sec

The above evaluation image was printed and abrasion resistance was evaluated. The difference in reflectance was used as an evaluation index for abrasion resistance. First, the image portion of the evaluation image was rubbed (10 times back and forth) with a new evaluation paper under a load of 0.5 kgf using a Gakushin-type friction fastness tester (AB-301: manufactured by Tester Sangyo Co., Ltd.). After that, a reflectometer (REFLECTOMETER MODEL TC-6DS: manufactured by Tokyo Denshoku Co., Ltd.) was used to measure the reflectance of the portion that had been rubbed with the new evaluation paper and the portion that had not been rubbed.

Then, the difference in reflectance between the portion that had been rubbed and the portion that had not been rubbed was calculated using the following formula. The resulting difference in reflectance was evaluated according to the following evaluation criteria. A rating of A to C was determined to be good.

Reflectance difference=(reflectance of the portion that had not been rubbed)−(reflectance of the portion that had been rubbed)

### Evaluation Criteria

A: Reflectance difference less than 1.0%
B: Reflectance difference 1.0% or more and less than 2.0%
C: Reflectance difference 2.0% or more and less than 4.0%
D: Reflectance difference 4.0% or more

### Evaluation of Image Sticking

Paper: OK top coat+ (128.0 g/m²)
(Sold by Canon Marketing Japan Inc.)
Toner laid-on level on paper: 0.70 mg/cm²
(Adjusted by DC voltage VDC of developer carrying member, charging voltage V_{D} of electrostatic latent image bearing member, and laser power)
Evaluation image: Image placed on the entire surface of the A3 paper
Test environment: Room temperature and low-humidity environment: temperature 23° C./humidity 10% RH
Fixing temperature: 100° C.
Process speed: 132 mm/see

A total of 100 sheets of the above evaluation image were printed on both sides, and the image sticking force was evaluated. A tape was attached to the center of the short side and the end of the long side of the topmost sheet of the stacked evaluation images so that the tape protruded vertically, the bottom evaluation image was fixed to the stand, and the image sticking force was measured when it was pulled horizontally at 300 mm/min with a digital force gauge (FGJN-2: manufactured by Nidec-Shimpo Corporation). The obtained image sticking force was evaluated according to the following evaluation criteria. A rank of B or higher was determined to be good.
A: less than 0.5 N
B: 0.5 N or more and less than 1.0 N
C: 1.0 N or more

### Charge Retention Rate Under High-Temperature and High-Humidity Environment

Paper: GFC-081 (81.0 g/m²) (Canon Marketing Japan Co., Ltd.)
Toner lain-on level on the paper: 0.35 mg/cm²

(Adjustment by the DC voltage VDC of the developer bearing member, the charging voltage V_{D} of the electrostatic latent image bearing member, and the laser power)
Evaluation image: an image of 2 cm×5 cm placed at the center of the A4 paper
Fixing test environment: high-temperature and high-humidity environment: temperature 30° C./humidity 80% RH (hereinafter “H/H”)
Process speed: 377 mm/see

The toner on the electrostatic latent image bearing member was sucked in and collected using a metal cylindrical tube and a cylindrical filter to calculate the triboelectric charge quantity of the toner. Specifically, the triboelectric charge quantity of the toner on the electrostatic latent image bearing member was measured by a Faraday-Cage.

The Faraday-Cage is a coaxial double cylinder in which the inner cylinder and the outer cylinder are insulated from each other. Where a charged body with a charge quantity Q is inserted into this inner cylinder, it is as if a metal cylinder of the charge quantity Q is present as a result of electrostatic induction. The induced charge quantity was measured by an electrometer (KEITHLEY 6517A, manufactured by Keithley Instruments Co., Ltd.), and the ratio (Q/M) obtained by dividing the charge quantity Q (mC) by the toner amount M (kg) in the inner cylinder was taken as the triboelectric charge quantity of the toner.

$$Triboelectric charge quantity of toner ( mC / kg ) = Q / M$$

First, the evaluation image was formed on the electrostatic latent image bearing member, the rotation of the electrostatic latent image bearing member was stopped before the image was transferred to the intermediate transfer member, the toner on the electrostatic latent image bearing member was sucked in and collected with a metallic cylindrical tube and a cylindrical filter, and the [initial Q/M] was measured.

Subsequently, the developing device was allowed to stand in the evaluation machine for 2 weeks in the H/H environment, then the same operations as before the storage were performed, and the charge quantity Q/M (mC/kg) per unit mass on the electrostatic latent image bearing member after the storage was measured. The initial Q/M per unit mass on the electrostatic latent image bearing member was taken as 100%, and the retention rate of Q/M per unit mass on the electrostatic latent image bearing member after the storage ([Q/M after the storage]/[initial Q/M]×100) was calculated and determined based on the following criteria. The evaluation of A to C, was determined to be good.

### Evaluation Criteria

A: Charge retention rate 90% or more
B: Charge retention rate 85% or more and less than 90%
C: Charge retention rate 80% or more and less than 85%
D: Charge retention rate less than 80%

### Storage Stability

A total of 5 g of toner was placed in a 100 mL resin cup and allowed to stand in a temperature- and humidity-variable thermostat (50° C., 54%) for 72 h, after which an agglomeration property of the toner was evaluated. The agglomeration property was evaluated by using the residual rate of the remaining toner as evaluation criteria when sieving with a 150 μm mesh with an amplitude of 0.5 mm for 10 sec using a powder tester PT-X manufactured by Hosokawa Micron Corporation. A rank of B or higher was determined to be good.

### Evaluation Criteria

A: Residual rate less than 2.0%
B: Residual rate 2.0% or more and less than 10.0%
C: Residual rate 10.0% or more

### Examples 2 to 29 and Comparative Examples 1 to 8

Evaluation was performed in the same manner as in Example 1, except that two-component developer 2 to two-component developer 37 were used instead of two-component developer 1. The evaluation results are shown in Table 8.

TABLE 8

| | Two- | | | | | | | | | | |
|---|---|---|---|---|---|---|---|---|---|---|---|
| | component | Low-temperature | | Abrasion | | | | Charge retention | | | |
| Example | developer | fixability | | resistance | | Image sticking | | property | | Storage stability | |
| No. | No. | % | Rank | % | Rank | N | Rank | % | Rank | % | Rank |
| 1 | 1 | 2.5 | B | 1.2 | B | 0.3 | A | 87 | B | 1.4 | A |
| 2 | 2 | 2.3 | B | 1.2 | B | 0.3 | A | 87 | B | 1.4 | A |
| 3 | 3 | 2.7 | B | 1.2 | B | 0.3 | A | 88 | B | 1.2 | A |
| 4 | 4 | 2.5 | B | 1.2 | B | 0.3 | A | 88 | B | 1.2 | A |
| 5 | 5 | 2.2 | B | 1.4 | B | 0.6 | B | 91 | A | 1.1 | A |
| 6 | 6 | 3.0 | B | 1.4 | B | 0.4 | A | 89 | B | 1.1 | A |
| 7 | 7 | 4.5 | C | 1.6 | B | 0.5 | B | 90 | A | 1.1 | A |
| 8 | 8 | 5.0 | C | 1.8 | B | 0.6 | B | 91 | A | 1.0 | A |
| 9 | 9 | 2.7 | B | 0.8 | A | 0.2 | A | 84 | C | 1.6 | A |
| 10 | 10 | 3.2 | B | 1.1 | B | 0.4 | A | 86 | B | 1.6 | A |
| 11 | 11 | 4.2 | C | 1.2 | B | 0.4 | A | 87 | B | 1.4 | A |
| 12 | 12 | 1.6 | A | 1.4 | B | 0.3 | A | 85 | B | 2.5 | B |
| 13 | 13 | 5.5 | C | 1.1 | B | 0.3 | A | 88 | B | 1.2 | A |
| 14 | 14 | 3.5 | B | 1.6 | B | 0.3 | A | 85 | B | 1.3 | A |
| 15 | 15 | 2.3 | B | 0.6 | A | 0.4 | A | 88 | B | 1.6 | A |
| 16 | 16 | 5.5 | C | 2.2 | C | 0.3 | A | 83 | C | 1.2 | A |
| 17 | 17 | 1.8 | A | 0.5 | A | 0.6 | B | 89 | B | 2.0 | B |
| 18 | 18 | 5.6 | C | 2.5 | C | 0.2 | A | 85 | B | 1.2 | A |
| 19 | 19 | 6.5 | D | 2.7 | C | 0.2 | A | 83 | C | 1.2 | A |
| 20 | 20 | 2.5 | B | 2.2 | C | 0.2 | A | 85 | B | 1.6 | A |
| 21 | 21 | 2.5 | B | 2.4 | C | 0.3 | A | 87 | B | 1.4 | A |
| 22 | 22 | 5.7 | C | 2.6 | C | 0.2 | A | 83 | C | 1.2 | A |
| 23 | 23 | 6.2 | D | 3.2 | C | 0.2 | A | 81 | C | 1.1 | A |
| 24 | 24 | 8.0 | D | 1.0 | B | 0.4 | A | 88 | B | 1.1 | A |
| 25 | 25 | 2.5 | B | 1.1 | B | 0.2 | A | 82 | C | 1.4 | A |
| 26 | 26 | 2.5 | B | 1.2 | B | 0.3 | A | 87 | B | 1.4 | A |
| 27 | 27 | 2.5 | B | 1.2 | B | 0.3 | A | 87 | B | 1.4 | A |
| 28 | 28 | 2.5 | B | 1.2 | B | 0.3 | A | 87 | B | 1.4 | A |
| 29 | 29 | 9.0 | D | 3.8 | C | 0.2 | A | 81 | C | 1.0 | A |
| C.E. 1 | 30 | 2.5 | B | 1.8 | B | 1.1 | C | 89 | B | 1.4 | A |
| C.E. 2 | 31 | 1.2 | A | 1.6 | B | 0.2 | A | 84 | C | 12.0 | C |
| C.E. 3 | 32 | 12.0 | E | 1.0 | B | 0.6 | B | 89 | B | 1.0 | A |
| C.E. 4 | 33 | 2.5 | B | 1.4 | B | 1.2 | C | 92 | A | 1.4 | A |
| C.E. 5 | 34 | 2.5 | B | 1.1 | B | 0.2 | A | 78 | D | 1.4 | A |
| C.E. 6 | 35 | 13.0 | E | 4.5 | D | 0.2 | A | 77 | D | 0.9 | A |
| C.E. 7 | 36 | 14.0 | E | 2.5 | C | 1.2 | C | 91 | A | 0.8 | A |
| C.E. 8 | 37 | 2.5 | B | 1.6 | B | 1.2 | C | 93 | A | 1.4 | A |

In the Table 8, “C.E.” indicates “Comparative example”.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-210561, filed Dec. 13, 2023, which is hereby incorporated by reference herein in its entirety.

What is claimed is:

1. A toner comprising a toner particle comprising a binder resin, wherein
the binder resin comprises a crystalline vinyl resin having a monomer unit represented by a following formula (1),
the crystalline vinyl resin comprises at least 5.0% by mass of the monomer unit represented by the following formula (1), based on a mass of the crystalline vinyl resin,
the toner particle comprises at least one polyvalent metal selected from the group consisting of Mg, Ca, Al, and Zn, and
a content ratio of the polyvalent metal in the toner particle is 25 to 500 ppm by mass: 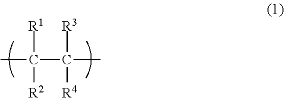
in the formula (1), at least two of R¹ to R⁴ are each independently —X—COOR⁵, and the remaining are each independently a hydrogen atom or an alkyl group having 1 to 4 carbon atoms, X is a single bond or an alkylene group having 1 or 2 carbon atoms, and R⁵ is an alkyl group having 16 to 30 carbon atoms.

2. The toner according to claim 1, wherein a content ratio of the crystalline vinyl resin, based on mass of the binder resin is 30 to 80% by mass.

3. The toner according to claim 1, wherein in the formula (1), at least two of R¹ to R⁴ are each independently —COOR⁵ (R⁵ is an alkyl group having 16 to 30 carbon atoms).

4. The toner according to claim 1, wherein in the formula (1), either one of R¹ and R², and either one of R³ and R⁴ are each independently —COOR⁵ (R⁵ is an alkyl group having 16 to 30 carbon atoms).

5. The toner according to claim 1, wherein the crystalline vinyl resin contains at least 30.0 mass % of the monomer unit represented by the formula (1), based on mass of the crystalline vinyl resin.

6. The toner according to claim 1, wherein a content ratio (ppm based on mass) of the polyvalent metal based on the mass of the toner particle and a content ratio (% by mass) of the monomer unit represented by the formula (1) based on mass of the toner particles satisfy a following formula (2):
$$( Content ratio of polyvalent metal ) / ( Content ratio of monomer unit represented by formula ( 1 ) ) \geq 1. ( ppm / \% by mass ) . \qquad ( 2 )$$

7. The toner according to claim 1, wherein a content ratio of the crystalline vinyl resin based on the mass of the binder resin is 50 to 80% by mass.

8. The toner according to claim 1, wherein R⁵ in the formula (1) is a linear alkyl group having 18 carbon atoms or a linear alkyl group having 22 carbon atoms.

9. The toner according to claim 1, wherein the crystalline vinyl resin comprises at least one monomer unit selected from the group consisting of a monomer unit represented by a following formula (N) and a monomer unit represented by a following formula (H): 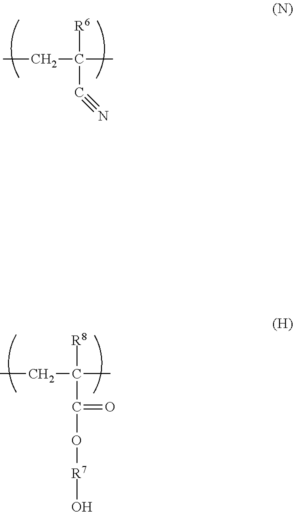
in formula (N), R⁶ is a hydrogen atom or a methyl group, in formula (H), R⁷ is an alkylene group having 1 to 4 carbon atoms, and R⁸ is a hydrogen atom or a methyl group.
